(19) United States
(12) Patent Application Publication
(10) Pub. No.: US 2024/0289600 A1
(43) Pub. Date: Aug. 29, 2024

(54) WAVELENGTH-PARALLEL PHOTONIC TENSOR CORE

(71) Applicant: HEWLETT PACKARD ENTERPRISE DEVELOPMENT LP, Spring, TX (US)

(72) Inventors: XIAN XIAO, Santa Barbara, CA (US); Stanley Cheung, Milpitas, CA (US); Sean Hooten, Milpitas, CA (US); Geza Kurczveil, Santa Barbara, CA (US); Raymond G. Beausoleil, Milpitas, CA (US)

(21) Appl. No.: 18/175,970

(22) Filed: Feb. 28, 2023

(51) Int. Cl. G06N 3/067; G02B 6/293; G06E 3/00

(52) U.S. Cl. CPC G06N 3/067; G02B 6/29343; G02B 6/29382; G02B 6/29395; G06E 3/008

(57) ABSTRACT

Systems and methods are provided for general matrix multiplication using wavelength parallel processing of a photonic tensor core. Examples of the systems and methods disclosed herein include encoding a second matrix into a plurality of optical signals based on a plurality of free spectral ranges (FSRs) of an array of resonator structures, the resonator structures having resonances tuned based on a first matrix. The optical signals can be input into input waveguides optically coupled to the array of resonator structures. A third matrix, representative of the first matrix multiplied by the second matrix, can be generated based on optical power output from the array of resonator structures.

### BACKGROUND

Driven by growing interest in artificial intelligence (AI), the global artificial neural network market is projected to grow at a significant rate. Artificial neural networks (ANN) and machine learning algorithms have the ability to learn from large data sets, which can create a machine having human-like decision making capabilities with low latency and high energy efficiency. Compared to electronic systems, neuromorphic photonics demonstrate improved performance in terms of multiplexing, energy dissipation, and crosstalk, which are beneficial for dense and high-bandwidth interconnects. Consequently, the neuromorphic photonic systems potentially offer operating speeds that are several orders of magnitude faster than neuromorphic electronics, along with higher efficiency.

ANNs are computing systems inspired by biological neural networks. The systems consist of a collection of connected nodes or neurons. Each neuron includes linear weights, a summation, and a nonlinear activation, which is a building block in ANNs that enables complex mappings between inputs and outputs for learning tasks.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example of a resonator structure loaded crossbar array in accordance with implementations disclosed herein.

FIGS. 2A and 2B illustrate example of add-drop filters that can be included in the crossbar array of FIG. 1 according to implementations disclosed herein.

FIGS. 3A and 3B are examples of transmission intensity output from add-drop filters according example implementations disclosed herein.

FIG. 4 is a schematic diagram of a photonic tensor core that can be utilized to perform GEMM in accordance with implementations disclosed herein.

FIG. 5 is a schematic diagram of another photonic tensor core according to an example implementation.

FIGS. 6A and 6B depict spectral line shapes of example optical signals on a drop waveguide of the photonic tensor core of FIG. 5 under various tuning conditions.

FIG. 7A depicts spectral line shapes of optical signals on a drop waveguide of photonic tensor core of FIG. 5 without tuning.

FIGS. 7B-7E depicts transmission intensities on drop waveguides as a function of tuning voltages applied to tuning mechanism for add-drop filters of the photonic tensor core of FIG. 5.

FIG. 7F shows a worst-case adjacent-channel crosstalk between tuned and untuned add-drop filters according to the example photonic tensor core of FIG. 5.

FIGS. 8A-8C illustrate an example tuning mechanism comprising a metal oxide semiconductor capacitor (MOSCAP) according to implementations of the present disclosure.

FIGS. 9A and 9B illustrate an example demultiplexer in accordance with an example implementation.

FIGS. 10A and 10B illustrate another example demultiplexer in accordance with another example implementation.

FIG. 11 is an example computing component that may be used to implement various features of general matrix multiplication (GEMM) in accordance with the implementations disclosed herein.

FIG. 12 is another example computing component that may be used to implement various features of GEMM in accordance with the implementations disclosed herein.

FIG. 13 is an example computer system that may be used to implement various features of GEMM of the present disclosure.

The figures are not exhaustive and do not limit the present disclosure to the precise form disclosed.

### DETAILED DESCRIPTION

Tensor cores play a role in fully-connected and convolutional layers of AI and machine learning (ML) accelerators. Tensor cores have been implemented as photonic tensor cores and electronic tensor cores. Photonic tensor cores may outperform electrical cores in terms of processing speed because photonic tensor cores utilize light to perform operations within a single clock cycle. Leveraging light to perform operations can significantly reduce computational latency because of the speed of light. Further, analog data can be encoded in photonic tensor cores through modulation of an optical amplitude (or phase) at a high frequency (e.g., approximately tens of GHz or more), which can increase data throughput. Further still, data movement occurs at the speed of light without length-dependent impedance, thus providing improved energy efficiency.

Conventional, photonic tensor cores with non-volatile photonic memory have been demonstrated for use in on-chip optical interference units. However, the conventional approaches have only been applied to matrix-vector multiplication (MVM) operations. MVM involves an input signal (e.g., input to a neuron) encoded with a 1×k vector that is multiplied by a n×m matrix, which generally is provided as weights of a neuron, to generate a weighted sum that can be activated using a nonlinear activation function.

Another photonic approach is through tensorized optical neural network (TONN) architectures. Existing TONN architectures utilize wavelength-parallel photonic tensor cores based on Mach-Zehnder interferometer (MZI) meshes. However, MZI meshes occupy a relatively large footprint due to the length of the phase shifters (e.g., approximately 100 μm). The large footprint can limit compactness of the overall chip layout.

Implementations of the technology disclosed herein provide for compact photonic tensor cores, and method of operation, for general matrix multiplication (GEMM) through parallel photonic processing. As used herein, GEMM refers to a multiplication of two matrices, where a first matrix is an m×n matrix (e.g., m rows by n columns) and a second matrix is an n×k matrix (e.g., n rows by k columns) and m, n, and k are integer values greater than one. In an example, n and m are equal integer values. In an example implementation, a wavelength-parallel photonic tensor core is provided that exploits multiple free spectral ranges (multi-FSRs) of a resonator-cavity crossbar array architecture. For example, matrix entries can be encoded using multi-FSRs, which can be processed by a single resonator-cavity crossbar array architecture in parallel. Thus, multi-FSRs can be utilized to perform a GEMM function within a single clock cycle using a single device. Compared to an electronic tensor core, which requests 2×N−1+K clock cycles to compute a product of a N×N matrix multiplied by a N×K matrix. The implementations disclosed herein also provide for a compact footprint through the use of the resonator-cavity crossbar array.

According to an illustrative implementation, a crossbar array is provided that comprises an array of add-drop filters formed at intersections of input bus waveguide and drop waveguides. In one example implementation, the add-drop filters are implemented as single resonator structures, such as a microring (MRR) resonator, evanescently coupled to bus waveguides and drop waveguides. In another example implementation, cascaded resonator structures, such as a double MRR configuration, are evanescently coupled to bus waveguides and the drop waveguides.

In either implementation, optical signals are input into the input waveguides of the crossbar array. Each optical signal can be encoded with an entry of the second matrix. Due to the periodicity of the resonances, each resonator structure has a plurality of resonance wavelengths (e.g., an initial resonance wavelength and at least ±(k-1) resonance wavelengths corresponding to multiple FSRs of the resonator structure). Thus, for example, a second n×k matrix can be encoded onto optical signals by encoding each k^{th} column using a different FSR and each n^{th} row using wavelength-division multiplexing (WDM). As a result, each entry of a given column of the second matrix can be encoded using WDM wavelength channels, and each column of the second matrix associated with an FSR.

As encoded optical signals propagate along the input waveguides, each add-drop filter can be configured to apply a weight based on tuning resonance frequencies of the resonator structures. For example, each resonator structure can be configured to align with an untuned initial resonance wavelength. To apply weights, resonance frequencies of each resonator structure can be adjusted by tuning mechanisms that tunes the intensity (e.g., amplitude) of optical signals coupled into the resonator structures and thus output onto the drop waveguides. Thus, a first matrix can be encoded into the crossbar array by selectively tuning the resonance frequencies of the resonator structures to according to each entry of the first matrix. As optical signals propagate along the input waveguides, the add-drop filters couple light from the input waveguide to the drop waveguide according to the tuned resonance frequencies. The resulting optical signal on the drop waveguide comprises the weight defined by the first matrix applied to each entry of the second matrix.

According to various implementations, demultiplexers can be provided at outputs of each drop waveguide. For example, each drop waveguide may carry optical signals comprising multiple FSRs, each of which define a row of the resultant matrix. The demultiplexers can be operated to separate output signals from the drop waveguides into separate output waveguides according to FSR. That is, demultiplexers are configured to filter each FSR onto a different output waveguide. The output waveguides may provide the optical signals to photodetectors. The photodetectors can be used to detect optical power and sum the weighted optical signals for a given FSR, thereby providing entries the resultant matrix (e.g., the first matrix multiplied by the second matrix). According to some implementations, the number of photodetectors may be equal to the number of entries in the resultant matrix. The demultiplexers may be coarse wavelength division multiplexing (CWDM) demultiplexers that can be implemented as de-interleavers and/or contra-directional couplers.

Accordingly, the implementations disclosed herein provide for a wavelength-parallel photonic tensor core architecture that leverages multi-FSR resonator structure crossbar array for performing GEMM. The implementations disclosed herein can be utilized in optical AI accelerators, such as TONNs. Furthermore, the implementations disclosed herein can be extended to any optical computing systems that require GEMM operations, including Ising machines, micro-wave photonics, optical networking, quantum photonics, etc.

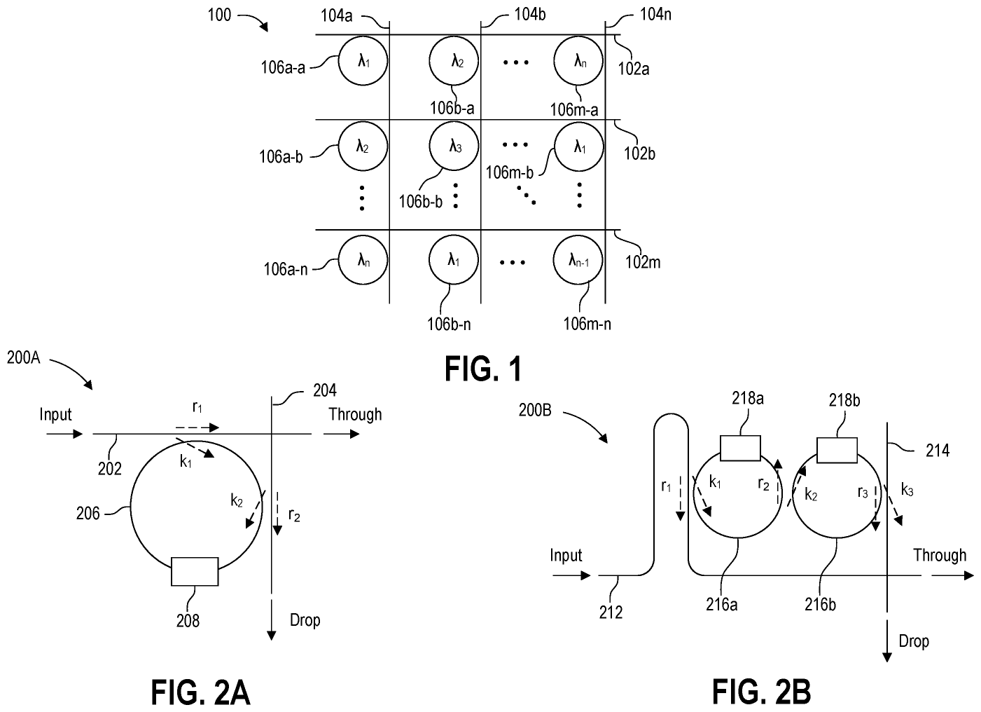

FIG. 1 is an example of a resonator structure loaded crossbar array 100. The crossbar array 100 comprises a plurality of first waveguides 102a through 102m and a plurality of second waveguides 104a through 104n. The plurality of first waveguides may be referred to herein as a plurality of input bus waveguides 102a-102m (collectively referred to herein as bus waveguides 102). The plurality of second waveguides may be referred to herein as a plurality of drop waveguides 104a-104n (collectively referred to herein as drop waveguides 104). Crossbar array 100 also comprises a plurality of add-drop filters 106a-a through 106m-n (collectively referred to herein as add-drop filters 106), where each add-drop filter is provided at an intersection of an input bus waveguide 102 and a waveguides 104. An add-drop filter functions to add and/or remove a narrow band of wavelengths from a broader optical signal carried on a bus waveguide. For example, input bus waveguide 102 may carry an optical signal having a broad band wavelength, and add-drop filter 106 operates to remove (e.g., drop) a narrow band wavelength of the optical signal from the input bus waveguide 102 onto the waveguide 104 via evanescent coupling Thus, waveguides 104 are referred to herein as drop waveguides 104. Crossbar array 100 is an example of an n×m crossbar array.

In some examples, some or all of the elements of the crossbar array 100 may be part of a photonic neuromorphic system, for example, crossbar array 100 may be formed of silica, silicon, or other Group IV material (e.g., germanium, silicon carbide, silicon germanium, and so on) platform. Crossbar array 100 may be provided on a common substrate (e.g., single chip) with one or more other parts of a photonic neuromorphic system.

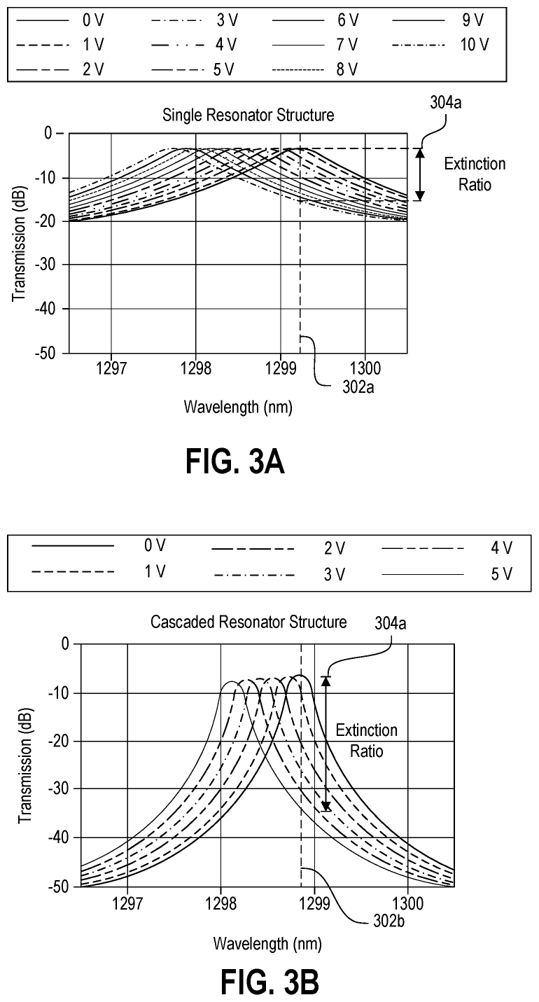

FIGS. 2A and 2B illustrate example implementations of add-drop filters that can be included in crossbar array 100. FIG. 2A depicts add-drop filter 200A, which is provided as a 2×2 resonator structure add-drop filter with a single resonator structure configuration. FIG. 2B depicts an example add-drop filter 200B, which is provided as a 2×2 resonator structure add-drop filter with a dual resonator structure configuration. Each add-drop filter 106 of FIG. 1 can be implemented as add-drop filters 200A or 200B, in accordance with embodiments disclosed herein.

Referring first to FIG. 2B, add-drop filter 200A comprises an input bus waveguide 202 and a drop waveguide 204 that is substantially perpendicular to the input bus waveguide 202. Add-drop filter 200A also comprises a resonator structure 206 that is evanescently coupled to input bus waveguide 202 at a first section of resonator structure 206 and evanescently coupled to the drop waveguide 204 at a second section of resonator structure 206. Input bus waveguide 202 may be a portion of a bus waveguide 102 of FIG. 1 and drop waveguide 204 may be a portion of a drop waveguide 104 of FIG. 1.

Resonator structure 206 includes a waveguide that optically couples to the input bus waveguide 202 and drop waveguide 204. The waveguide may be a closed loop formed of semiconductor material, such as silicon or other Group IV material. The shape of the loop may be, for example but not limited to, circular, elliptical, a racetrack shape, etc., thereby forming a microring resonator. Resonator structure 206 may have an initial resonance wavelength (λ) defined by the round-trip length of the resonator structure 206 (e.g., the radius in the case of an MRR). Resonator structure 206 also comprises a plurality of resonance frequencies separated by an integer number of FSRs of the resonator structure 206 (e.g., Δ+ΔNλ, where N is a non-zero integer).

An input optical signal on input bus waveguide 202 can be coupled into the resonator structure 206 based on the resonance frequency of the resonator structure 206. For example, an input optical signal on input bus waveguide 202 that has a wavelength aligned with a resonance frequency of the resonator structure 206 can be coupled into resonator structure 206. Similarly, an optical signal resonating in resonator structure 206 can be coupled into drop waveguide 204. The electric field transmission function of a drop waveguide 204 can be provided as follows:

$${T}_{drop\_single \_MRR} = \frac{- {k}_{1} {k}_{2} {A}^{1 / 4} {e}^{- j β L / 4}}{1 - {r}_{1} {r}_{2} A {e}^{- j β L}} \qquad Eq . 1$$

where k₁ and r₁ are the electric field transmission and coupling coefficient, respectively, between the input bus waveguide 202 and the resonator structure 206, k₂ and r₂ are the electric field transmission and coupling coefficient between the drop waveguide 204 and the resonator structure 206, A is a fraction of the electric-field amplitude that remains upon a round trip in the resonator structure 206, L is the round-trip length of resonator structure 206, β=(2πn_{eff})/λ is a propagation constant in the resonator structure 206, n_{eff} is the effective refractive index of the waveguide forming the resonator structure 206, and λ is the free-space wavelength of the input optical signal.

Transmission intensity of a signal on drop waveguide 204 can be calculated as the absolute value of Eq. 1 squared (e.g., |T_{drop_single_MRR}|²). By tuning the effective refractive index of the resonator structure 206, the transmission intensity on the drop waveguide 204 can be adjusted. For example, tuning the effective refractive index causes a blue-shift in the resonance frequency of the resonator structure, which for a given input wavelength, tunes the amount of optical signal coupled into the resonator structure 206 and impacts the intensity of the optical signal coupled into the drop waveguide 204.

Resonator structure 206 comprises a tuning mechanism 208 disposed thereon that is configured to tune the effective index of the waveguide of resonator structure 206. The tuning mechanism 208 can be implemented through thermal-optical tuning (e.g., a resistor coupled to the waveguide that generates heat based on an applied voltage), electro-optical tuning (e.g., coupling a PN diode to the waveguide), metal-oxide-semiconductor capacitor (MOSCAP) tuning, or the like. The tuning mechanism 208 can be controlled, as described below, to adjust the effective refractive index of the resonator structure 206, thereby tuning the transmission intensity on the drop waveguide 204. Thus, in the case of a matrix, entries of a matrix can be encoded into each resonator structure 206 by tuning the effective refractive index of each resonator structure 206 via tuning mechanism 208. In example implementations, weights can be encoded by tuning the transmission intensity.

Turning to FIG. 2B, add-drop filter 200B comprises an input bus waveguide 212 and a drop waveguide 214 that is substantially perpendicular to the input bus waveguide 212. Input bus waveguide 212 and drop waveguide 214 may be similar to input bus waveguide 202 and drop waveguide 204, respectively. Add-drop filter 200B also comprises a cascaded resonator structure formed for a first resonator 216a and a second resonator 216b. First resonator 216a is evanescently coupled to input bus waveguide 202 at a first section of first resonator 216a and is evanescently coupled to the second resonator 216b at a second section of first resonator 216a. Second resonator 216b is evanescently coupled the drop waveguide 204 at a second section of second resonator 216b.

Each of first resonator 216a and second resonator 216b includes a waveguide. The waveguides may be a closed loop formed of semiconductor material, such as silicon or other Group IV material. The shape of the loop may be, for example but not limited to, circular, elliptical, a racetrack shape, etc., thereby forming a microring resonator. Each resonator structure 216 may have an initial resonance wavelength (λ) defined by the round-trip length of the respective resonator structure 216. In some implementations, the round-trip length of each structure 216 may be substantially the same so as to have a common initial resonance wavelength. Each resonator structures 216 also comprises a plurality of resonance frequencies separated by an integer number of FSRs of the respective resonator structure 216.

An input optical signal on input bus waveguide 212 can be coupled into the first resonator 216a based on the resonance frequency of the first resonator 216a. The optical signal resonating in first resonator 216a can be coupled into second resonator 216b, and an output signal can be coupled into drop waveguide 214. The electric field transmission function of on drop waveguide 214 can be provided as follows:

$${T}_{drop\_double \_MRR} = \frac{j {k}_{1} {k}_{2} {k}_{3} A {e}^{- j β L}}{1 - {r}_{1} {r}_{2} A {e}^{- j β L} - {r}_{2} {r}_{3} A {e}^{- j β L} + {r}_{1} {r}_{3} {A}^{2} {e}^{- j 2 β L}} \qquad Eq . 2$$

where k₁ and r₁ are the electric field transmission and coupling coefficient, respectively, between the input bus waveguide 212 and the first resonator 216a, k₂ and r₂ are the electric field transmission and coupling coefficient between first resonator 216a and second resonator 216b, k₃ and r₃ are the electric field transmission and coupling coefficient between the drop waveguide 214 and the second resonator 216b, A is a fraction of the electric-field amplitude that remains upon a round trip in one of first resonator 216a and second resonator 216b, L is the round-trip length of one of first resonator 216a and second resonator 216b (according to various implementations, the round-trip length of first resonator 216a and second resonator 216b may be substantially the same), β=(2πn_{eff})/λ is a propagation constant in in one of first resonator 216a and second resonator 216b (according to various implementations, the round-trip length of first resonator 216a and second resonator 216b may be substantially the same), n_{eff} is the effective refractive index of the waveguides forming the first resonator 216a and second resonator 216b (which may be substantially the same), and λ is the free-space wavelength of the input optical signal.

Similar to add-drop filter 200A, the transmission intensity of a signal on drop waveguide 214 can be calculated as the absolute value of Eq. 2 squared (e.g., |T_{drop_double_MRR}|²). Additionally, first resonator 216a and second resonator 216b comprises a first tuning mechanism 218a and a second tuning mechanism 218b disposed thereon, respectively. Each of first tuning mechanism 218a and second tuning mechanism 218b may be similar to tuning mechanism 208 of add-drop filter 200A. Thus, first tuning mechanism 218a and second tuning mechanism 218b can be controlled to adjust the effective refractive index of first resonator 216a and second resonator 216b, respectively, thereby tuning the transmission intensity that is coupled onto the drop waveguide 214.

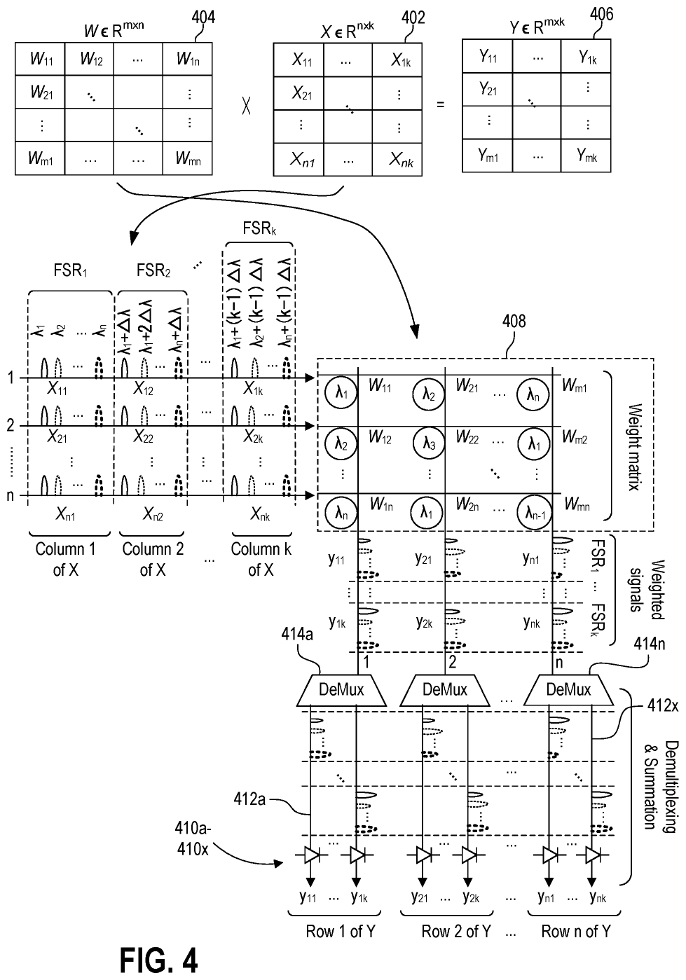

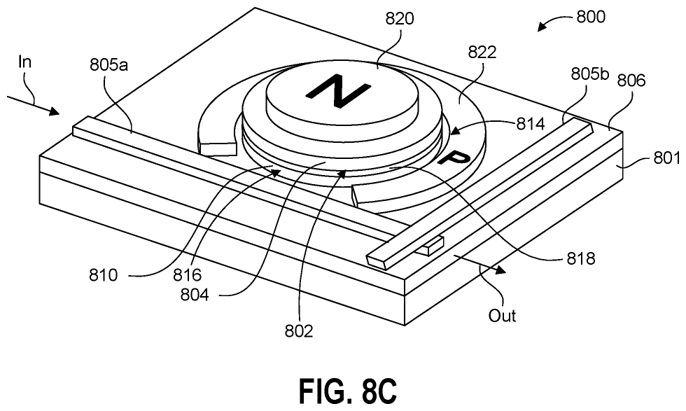

FIGS. 3A and 3B are examples of transmission intensity on a drop waveguide according example implementations of add-drop filters. FIG. 3A shows line shape spectral transmission intensities in dB on drop waveguide 204 as a function of wavelength, where the add-drop filter is provided as add-drop filter 200A. FIG. 3B provides transmission intensity on drop waveguide 214 as a function of wavelength, where the add-drop filter is provided as add-drop filter 200B. In the examples of FIGS. 3A and 3B, the tuning mechanisms are implemented using MOSCAP tuning, as described below in connection with FIGS. 8A-8C.

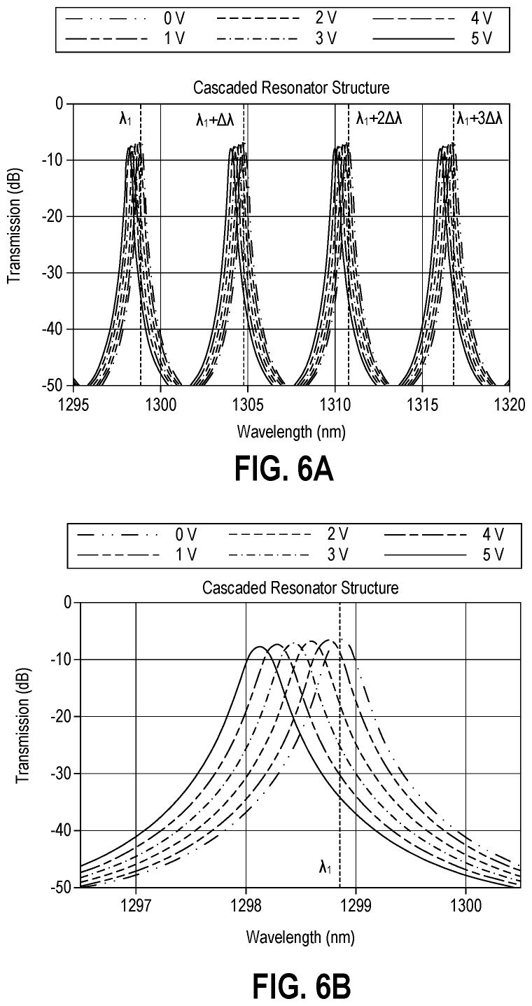

FIGS. 3A and 3B each depict an extinction ratio 304a and 304b at an initial resonance wavelengths 302a and 302b, respectively. of resonator structure 206 and the cascaded resonator structure of 200B (e.g., first resonator 216a and second resonator 216b), respectively. The extinction ratio is shown as the intensity transmission range from a peak intensity of the initial resonance wavelength to a full width half maximum (FWHM) of a maximum tuning applied (e.g., 10 V in FIG. 3A and 5 V in FIG. 3B). The extinction ratio can be used to define the tuning range of the transmission intensity on the respective drop waveguide. For example, the extinction ratio may define a transmission tuning range between a maximum intensity and a lower, minimum intensity across which the resonator structure can be tuned. Thus, in the case neuromorphic computing systems, the extinction ratio may define the tuning range of weights in a weight matrix. With reference to FIG. 3A, by setting the input signal wavelength to the initial resonance wavelength of the resonator structure 206 (shown as dashed line 302a), and increasing a tuning voltage from 0 V to 10 V, an extinction ratio (e.g., difference between the transmission at 0 V and the transmission at 10 V) of approximately 10 dB can be achieved. In the case of 200B, the finesse (e.g., sharpness) of the spectra can be increased relative to the spectra of add-drop filter 200A (e.g., as shown in FIG. 3A). As a result, the add-drop filter 200B can achieve an extinction ratio of approximately 27.8 dB with tuning voltage of 5 V, as shown in FIG. 3B.

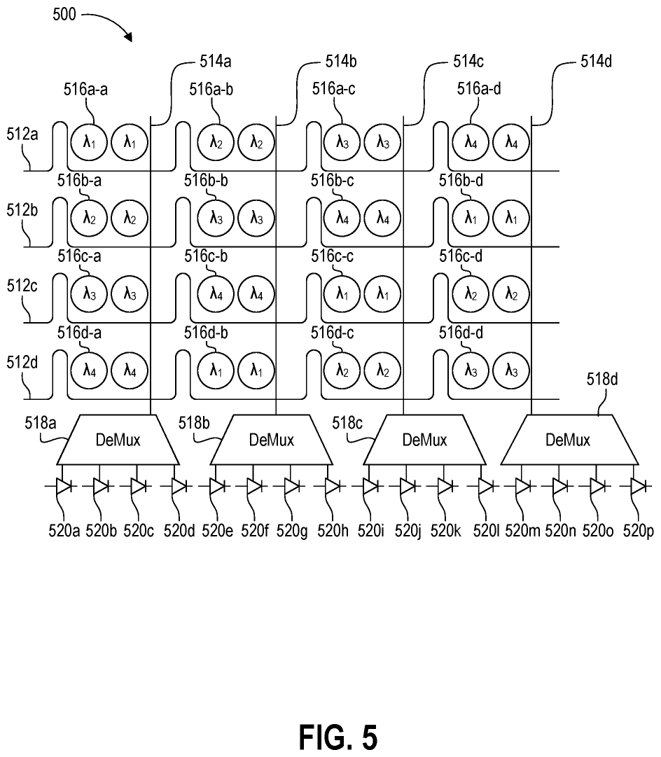

FIG. 4 provides a schematic diagram of a photonic tensor core 400 that can be utilized to perform GEMM in accordance with implementations disclosed herein. Tensor core 400 leverages WDM and multi-FSRs for encoding a first matrix 402 into optical signals that can be input into a resonator structure loaded crossbar array 408. By utilizing WDM and multi-FSRs, crossbar array 408 can execute GEMM through parallel photonic processing. Crossbar array 408 can be implemented as crossbar array 100 of FIG. 1. For illustrative purposes, reference numbers for crossbar array 408 are not included in FIG. 4 and reference will be made to FIG. 1. Crossbar array 408 can be encoded with first matrix 404, such that when second matrix 402 is input into crossbar array 408, second matrix 402 is multiplied with first matrix 404 to produce resultant matrix 406.

In the illustrative example of FIG. 4, second matrix 402 is provided as an n×k matrix. Second matrix 402 may be a matrix containing input values of a neuron. First matrix 404 is a m×n matrix as weights to be multiplied with the input values. Values of n, k, and m are integer values greater than one. When first matrix 404 is multiplied with second matrix 402, resultant matrix 406 is provided as a product matrix. In an illustrative example, an m×n matrix, where n is greater than m, may be enabled by crossbar array 100 through n wavelengths and can be realized by an n×n matrix. Thus, according to an illustrative implementation, m may be equal to n such that crossbar array 408 is realized as a n×n matrix.

Entries of second matrix 402 can be encoded into optical signals that are supplied to separate input bus waveguides 102 of crossbar array 408. A plurality of input optical signals (shown in FIG. 4 as signals 1 through n) can be encoded with entries of second matrix 402. For example, input optical signal 1 can be provided to input bus waveguide 102a, input optical signal 2 provided to input bus waveguide 102b, and so on. Due to the periodicity of resonances, resonator structures of the add-drop filters 106 include a plurality of resonance wavelengths (e.g., an initial resonance wavelength and at least ±(k-1) resonance wavelengths corresponding to multiple FSRs of the resonator structure). In an illustrative implementation, each column of the second matrix 402 can be encoded according to a different FSR. For example, as shown in FIG. 4, column 1 of second matrix 402 can be associated with a first FSR (FSR₁), column 2 of second matrix 402 associated with a second FSR (e.g., FSR₂), and so on. Entries of second matrix 402 can be encoded onto each optical signal using WDM wavelength channels. Entries for each row of second matrix 402 can be encoded onto a single input optical signal using WDM wavelengths to encode a given entry value, and each entry of a row is separated by different FSRs indicating different columns. For example, input optical signal 1 may be encoded with entries for x₁₁ through x₁ₖ, where each entry is encoded using WDM channel wavelengths to represent the entry and encoded within a different FSR to designate the different columns. Similarly, each input optical signal n can be encoded with entries xₙ₁ through xₙₖ using WDM channels wavelengths and associated with different FSRs according to columns of second matrix 402.

As described above, crossbar array 408 comprises an array of add-drop filters 106 formed at intersections of the input bus waveguide 102 and the drop waveguides 104. Each add-drop filters 106 can be configured for an initial resonance wavelength, for example, based upon a round-trip length of the resonator structure thereof. Accordingly, each of add-drop filters 106 may correspond with a WDM wavelength channel. In the example implementation, each of add-drop filters 106 of a given row of crossbar array 408 is configured to have a different resonance wavelength and each add-drop filters 106 of a given column of crossbar array 408 is also configured to have a different resonance wavelength. Weight matrix W (e.g., first matrix 404) can be realized by crossbar array 408 formed by n rows and m columns of add-drop filters 106, as described above. In an illustrative implementation, crossbar array 408 is realized by n×n add-drop filters 106, where m is equal to n.

By tuning resonance frequencies of add-drop filters 106 using tuning mechanism, as described above, a tuned amount of optical power can be coupled from respective input bus waveguides 102 and dropped onto respective drop waveguides 104. Tuning of the resonance frequencies controls the amount of optical power that is dropped, which represents a multiplication operation of two entries in matrix-to-matrix multiplication. Thus, crossbar array 408 can be encoded according to the first matrix 404, for example, by encoding each entry of first matrix 404 into each of add-drop filters 106 by adjusting the resonance frequency of each of add-drop filters 106.

As noted above, due to periodicity of the resonances, each add-drop filter 106 has a plurality of resonance wavelengths, such as the initial resonance wavelength and at least ±(k-1) resonance wavelengths corresponding to multiple FSRs. The tuning of the resonance frequency to apply a weight to each add-drop filters 106 may apply a substantially similar weight to each resonance wavelength of a given add-drop filters 106. Thus, each of add-drop filters 106 can be tuned to apply the associated weight to each FSR on an input signal. Further, the crossbar array 408 can apply weights to each encoded input signal 1 through n, each of which are encoded with all entries of a given row of second matrix 402, in parallel (e.g., at the same time), and output a weighted optical signal onto the drop waveguides 104. The weighted optical signal on each drop waveguide 104 comprises modulated transmission intensities for each WDM wavelength channel and each FSR representing each entry of second matrix 402, where the modulated transmission intensities correspond to the tuned weights.

As a more detailed explanation, when considering a single FSR, such as the FSR₁ shown in FIG. 4, each column and each row of the crossbar array 408 have different initial resonances λ₁ to λₙ. At the input of the crossbar array 408, the first column of second matrix 402, e.g., vector {x₁₁, . . . , xₙ₁} in column 1 of second matrix 402 can be encoded using the WDM wavelength channels λ₁, . . . , λₙ. That is, for example, data for entry x₁₁ of second matrix 402 is encoded using each WDM wavelength channel, data for entry x₂₁ is encoded using each WDM wavelength channel, and so on. Then, optical signal 1 encoded using WDM corresponding to entry x₁₁ can be supplied to input bus waveguide 102a, optical signal 2 corresponding to entry x₂₁ can be provided to input bus waveguide 102b, and so on.

With continued to reference to a single FSR, each encoded signal is weighted and dropped by each respective row of add-drop filters 106. For example, each WDM wavelength channel used to encode entry x₁₁ in optical signal 1 can be weighted and dropped by respective add-drop filter 106 coupled to input bus waveguide 102a. That is, each of add-drop filters 106 may have an initial reference wavelength corresponding to a WDM wavelength channel, which is tuned according to an entry of first matrix 404. Each add-drop filter 106 in the row may be tuned to drop a given WDM wavelength channel and to apply the preproperate weight from first matrix 404. For example, add-drop filter 106a may be provided to act on WDM wavelength channels λ₁ and tuned so to apply a weight defined at entry w₁₁ of first matrix 404. Add-drop filter 106a then drops the weighted optical signal onto drop waveguide 104a. The optical signal on input bus waveguide 102a proceeds to each subsequent add-drop filter 106 of the row. A similar process occurs for each add-drop filters 106 and associated WDM wavelength channel as indicated in FIG. 4.

A plurality of photodetectors 410a-410x (collectively referred to herein as photodetectors 410) can be coupled to output waveguides 412a-412x (collectively referred to herein as output waveguides 412). The photodetectors 410 function to detect the optical signal a respective output waveguide 412 and sum the weighed signals from each respective drop waveguide 104. Thus, each entry of a first column of resultant matrix 406 is the summation of all the weighted optical signals of the first column of second matrix 402 (e.g., yᵢ₁=Σⱼ₌₁ⁿwᵢⱼxⱼ₁). In this way, the first column of second matrix 402 can be implemented with a single FSR.

Each column of second matrix 402 can be treated as a vector similar to the foregoing, which each vector encoded using a different FSR. For example, each add-drop filters 106 has a plurality of resonance wavelengths, such as λᵢ+Δλ, λᵢ+2Δλ, . . . , λᵢ+(k-1)Δλ, where ΔA is the FSR and i=1, . . . , n (e.g., the number of WDM wavelength channels). Photonic tensor core 400 leverages this periodicity to encode each column of second matrix 402 using a different FSR. For example, as shown in FIG. 4, FSR₁ can be used to encode a first column of second matrix 402, FSR₂ can be used to encode a second column, and so on to FSRₖ, which can be used to encode the k^{th} column. As described above, entries for each column are encoded using WDM wavelength channels.

Within multiple FSRs, line shapes of spectral response for a add-drop filters 106 at the multiple resonance frequencies of each FSR may be similar. This similarity permits the weight value encoded into the add-drop filters 106 to be approximately the same at each resonant wavelength for the different FSRs. As a result, by encoding the k columns of second matrix 402 in k different FSRs, the multiplication of first matrix 404 with second matrix 402 can be realized using photonic tensor core 400.

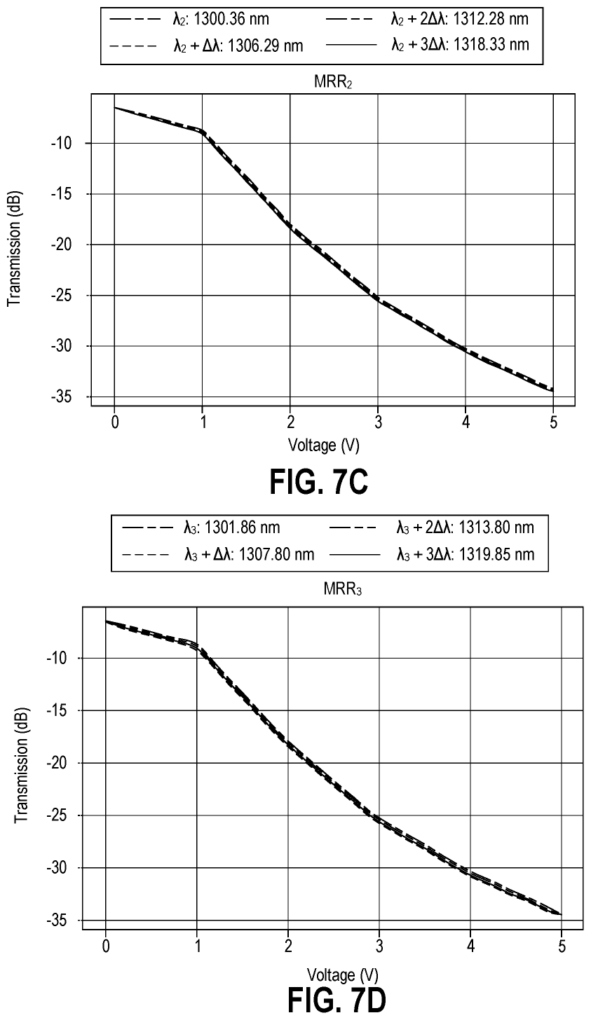

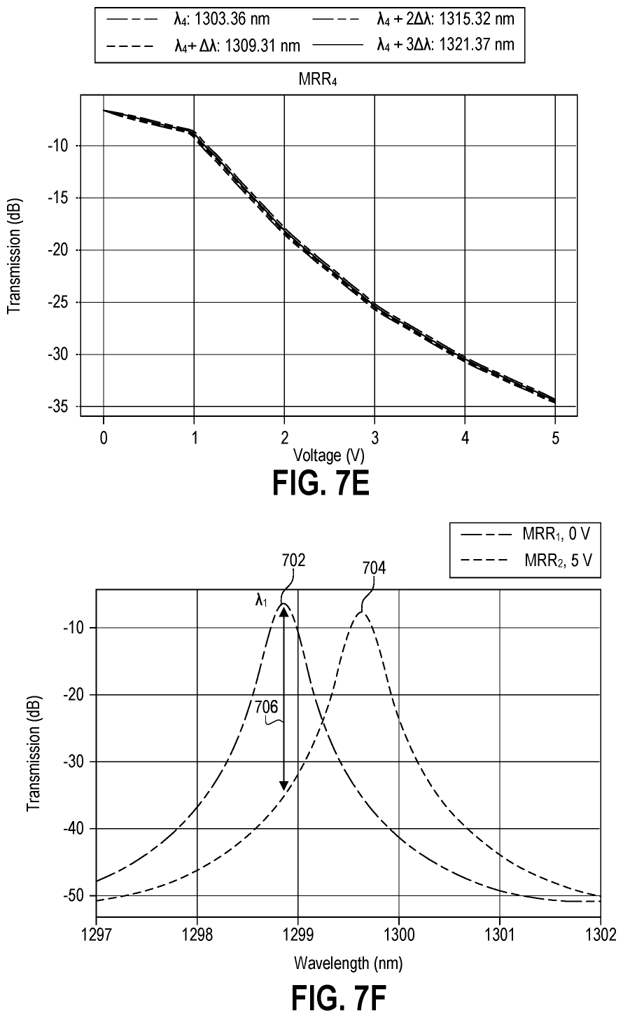

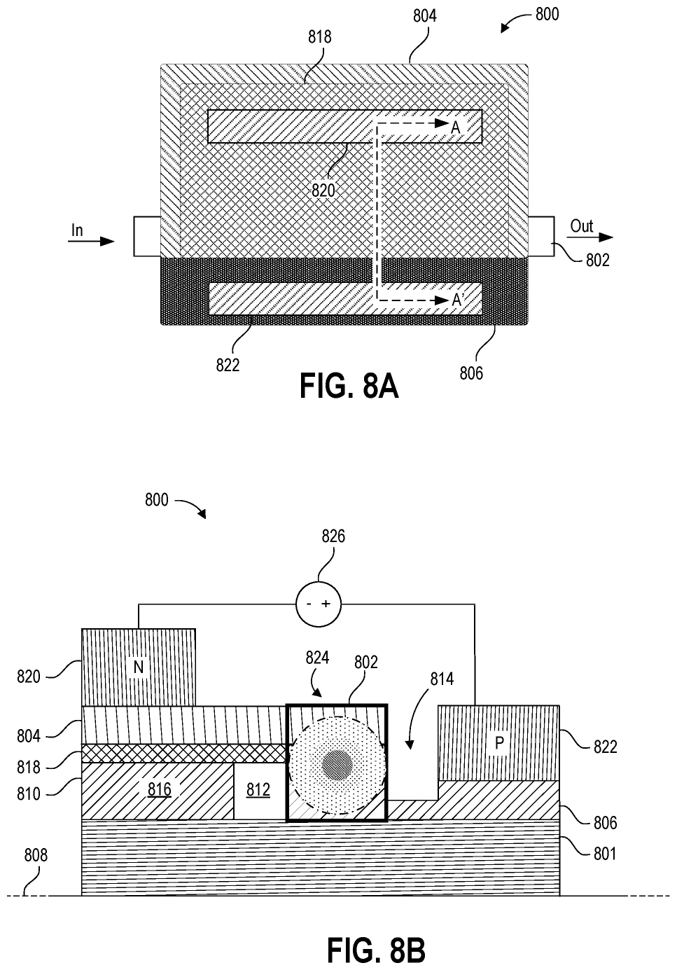

In various implementations, Δλ for the multiple FSRs may be equal to or greater than the wavelength channel spacing, where channel spacing is a difference in wavelength between adjacent WDM channels (e.g., difference between λ₂ and λ₁). In an example, Δλ may be greater than n times the wavelength channel spacing. Otherwise, photonic tensor core 400 may not be able to distinguish between a WDM wavelength channel of one FSR and a WDM wavelength channel of another FSR. As an illustrative example, λ₁ for FSR₁ and λₙ+Δλ of FSR₂ may overlap resulting in crosstalk such that they are indistinguishable. Further details with respect to this condition are provided below in connection with FIG. 7F.

Each drop waveguide 104 carries a weighted optical signal representative of entries of a corresponding row of the resultant matrix 406. That is, for example, drop waveguide 104a may carry weighted signals dropped onto drop waveguide 104a from each add-drop filters 106 coupled thereto (e.g., add-drop filters 106a-1, 106b-1, . . . 106n-1). The dropped signals from each add-drop filters 106 includes wavelengths of light from each FSR, along with each WDM wavelength channel. Thus, at the outputs of drop waveguide 104, the optical signal is a mix of signals for each entry of a given row resultant matrix 406.

To differentiate between the different FSRs and thus provide distinct entries, photonic tensor core 400 also comprises a plurality of demultiplexers 414a-414n (collectively referred to herein as demultiplexers 414) coupled to outputs of the drop waveguides 104. Each demultiplexers 414 is configured to filter each FSR onto individual output waveguides 412 coupled thereto. The demultiplexers 414 may be provided as coarse wavelength division multiplexing (CWDM) demultiplexers that can be implemented as de-interleavers, contra-directional couplers, or the like. Each demultiplexer 414 can be operated to separate output signals from into individual output waveguides 412 according to different FSR. For example, demultiplexer 414a is receives weighted signals from drop waveguide 104a, which contains optical signal representative of the first row of resultant matrix 406 (e.g., values y₁₁ though y₁ₖ). Demultiplexer 414a may separate (e.g., filter) each FSR onto a distinct output waveguide 412, such that an optical signal on each output waveguides 412 is indicative of a single entry in the first row of resultant matrix 406. Photodetectors 410 coupled to each output waveguide 412 detects the optical signals on a respective output waveguide 412 and sums the detected signal. As a result, the optical power detected by each photodetectors 410 is a value for a corresponding entry of resultant matrix 406. In this way, each column of second matrix 402 can be implemented with a different FSR, which is multiplied by first matrix 404 to provide resultant matrix 406.

FIG. 5 is a schematic diagram of a photonic tensor core 500 according to an example implementation.

Photonic tensor core 500 is an example implementation of photonic tensor core 400 provided as a 4 by 4 resonator loaded cross bar array 510. Photonic tensor core 500 comprises four input bus waveguides 512a through 512d and four drop waveguides 514a through 514d, with 16 add-drop filters 516a-a through 516d-d coupled to the input and drop waveguides as described above. A plurality of demultiplexers 518a through 518d are coupled to respective drop waveguides 514. Output waveguides couple the demultiplexers 518 to photodetectors 520a through 520p. Each demultiplexer 518 may be substantially similar demultiplexers 414 of FIG. 4 and each photodetector 520 may be substantially similar to photodetectors 410 of FIG. 4.

In the example illustrated in FIG. 5, each add-drop filter 516 is implemented as add-drop filter 200B of FIG. 2B having cascaded resonator structure configuration. As described above, the cascaded resonator structure configuration (also referred to as double-MRR or dual-MRR configuration) may achieve a larger extinction ratios and reduced crosstalk as compared to a single configuration (e.g., add-drop filter 200A). Each add-drop filter 516 of each column is designed to resonate at different WDM wavelength channels (e.g., λ₁, λ₂, λ₃, and λ₄) and each add-drop filter 516 of each row is designed to resonate at the different WDM wavelength channels. Furthermore, as described above, each add-drop filter 516 comprises one or more tuning mechanisms (not shown in FIG. 5) that can be used to tune the transmission intensity output onto respective drop waveguides 514. For example, by adjusting a voltage applied to the tuning mechanism, the resonate frequency of each add-drop filter 516 can be blue-shifted thereby tuning the transmission intensity of an input signal according to a first matrix (e.g., first matrix 404 of FIG. 4).

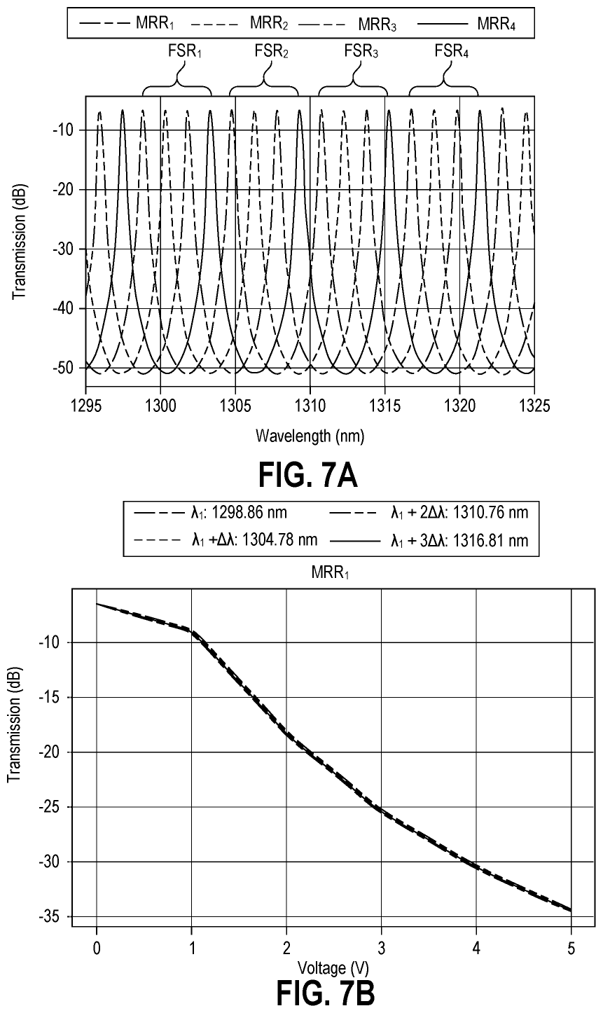

For example, FIGS. 6A and 6B depict spectral line shapes of example optical signals on one drop waveguide of photonic tensor core 500 under various tuning conditions. Particularly, FIGS. 6A and 6B illustrate spectral line shapes output onto drop waveguide 514d from add-drop filter 516b-d, where a voltage applied the tuning mechanisms of add-drop filter 516b-d is adjusted from 0 V to 5 V. FIG. 6A shows transmission spectral line shapes at the wavelengths of multiple FSRs, such as λ₁ (e.g., FSR₁), λ₁+Δλ (e.g., FSR₂), λ₁+2Δλ (e.g., FSR₃), and λ₁+3Δλ (e.g., FSR₄), and transmission spectral line shapes as a result of each voltage condition applied to the tuning mechanism. FIG. 6B shows a zoom-in view of transmission spectral line shape on drop waveguide 516b-d for FSR₁ (e.g., initial resonance wavelength of λ₁) with an applied voltages tuned from 0 V to 5 V.

In the example implementation shown in FIGS. 6A and 6B, WDM channel spacing is approximately 1.5 nm and FSR spacing (e.g., Δλ) is approximately 6 nm. Thus, the condition that Δλ for the FSRs is equal to or greater than WDM channel spacing is satisfied, ensuring that signals are distinguishable. Particularly, in this example, Δλ for the FSRs is equal to or greater than 4 times the WDM channel spacing. Furthermore, in the example implementation, the radius of add-drop filter 516b-d is designed to be 11.858 μm, which translates to an initial, untuned resonance wavelength λ₁ of 1298.86 nm. In the case of the cascaded resonator structure, both resonator structures may be designed to have the substantially same radius so to resonate at the same resonance frequency. From FIG. 6B, it can be observed that as tuning is applied to the resonator structure the optical response blue shifts and the extinction ratio at λ₁ is 27.8 dB between 0V and 5V tuning.

Referring to FIG. 5 again, initial resonance wavelength of each add-drop filter 516 can be achieved by varying the radii of each add-drop filters 516. In an illustrative example, initial resonance wavelengths, without tuning, are provided as follows: λ1=1298.86 nm, λ2=1300.36 nm, λ3=1301.86 nm, and/4=1303.36 nm, which can be achieved by providing add-drop filters 516 having radii of 11.858 μm, 11.875 μm, 11.892 μm, and 11.909 μm, respectively. That is, for example, resonator structures of add-drop filters 516a-a, 516b-d, 516c-c, and 516b-d have a radius of 11.858 μm; resonator structures of add-drop filters 516b-a, 516a-b, 516d-c, and 516c-d have a radius of 11.875 μm; and so on.

FIG. 7A depicts spectral line shapes of optical signals on drop waveguide 514 of photonic tensor core 500 without tuning. Particularly, FIG. 7A illustrates spectral line shapes output onto each drop waveguide 514 from add-drop filters 516, where a voltage applied the tuning mechanisms is 0 V. FIG. 7A also shows the multiple peaks in the spectral line shapes for each FSR grouping. That is, a first FSR₁ comprises four peaks of each initial resonance wavelength of add-drop filters 516 of the first column of resonator loaded cross bar array 510 (e.g., add-drop filters 516a-a, 516b-a, 516c-a, and 516d-a). A second FSR₂ comprises four peaks of each next resonance wavelength (e.g., λₙ+Δλ) of add-drop filters 516 of the second column of resonator loaded cross bar array 510 (e.g., add-drop filters 516a-b, 516b-b, 516c-b, and 516d-b). A third FSR₃ and fourth FSR₄ each comprises four peaks of each respective next resonance wavelength (e.g., λₙ+2Δλ and λₙ+3Δλ, respectively) of add-drop filters 516 of the third and fourth columns of resonator loaded cross bar array 510, respectively.

FIGS. 7B-7E depicts weight curves as transmission intensities on drop waveguides as a function of tuning voltages applied to tuning mechanism for the add-drop filter 516. Each of FIGS. 7B-7E shows transmission intensities for the four FSRs of FIG. 7A of a respective add-drop filter 516. For example, FIG. 7B illustrates transmission intensities that can be output from an add-drop filter implemented as one of add-drop filters 516a-a, 516b-a, 516c-a, and 516d-a, which is configured to have an initial resonance wavelength of λ₁. FIG. 7B also shows the transmission intensity for each FSR of the same add-drop filter (e.g., λ₁+Δλ, λ₁+3Δλ, and λ₁+3Δλ). FIGS. 7C-7E each correspond to add-drop filters configured for a different initial resonance wavelength. As shown in FIGS. 7B-7E, weight curves for each FSR of a given add-drop filter 516 are nearly identical, with extinction ratios of approximately 27.8 dB. Thus, tuning applied to a given add-drop filter 516 can be used to apply a common weight to a the different FSRs.

FIG. 7F shows an example of adjacent-channel crosstalk between a first add-drop filter 516 that is not tuned and a second add-drop filter 516 that is tuned to 5V in this example. In the case of FIG. 7F, a first spectral line shape 702 is shown illustrating an optical response on a drop waveguide from a first add-drop filter 516 with no tuning and configured for λ₁ (e.g., 516b-d) and a second spectral line shape 704 of a add-drop filter 516 configured for λ₂ (e.g., 516c-d) and tuned by applying 5 V. FIG. 7F shows an example worst-case acceptable crosstalk, where first spectral line shape 702 and second spectral line shape 704 are distinguishable. That is, for example, a demultiplexer can be function to filter signals represented by line shapes 702 and 704 onto distinct output waveguides according to FSR. In this example, the conditions shown in FIG. 7F illustrate a limit of the conditions where Δλ for the multiple FSRs is equal to or greater than the wavelength channel spacing. That is, for example, as the Δλ for the multiple FSRs becomes less than the wavelength channel spacing, the optical response curves begin to overlap. In the case where the optical response curves overlap, for example, a demultiplexer may be unable function to separate the signals onto separate output waveguides because the optical response curves would overlap in wavelength. Thus, portions of signals represented by line shape 704 would be attributed to signals represented by line shape 720. FIG. 7F illustrates that, for the example implementation of FIG. 5, the worst-case acceptable crosstalk is approximately −28 dB (shown as arrow 706).

Intensity tuning (and thus tuning of a weight applied to an input signal) according to the implementations disclosed herein may be achieved through many different approaches. For example, tuning mechanisms described throughout the present disclosure, such as tuning mechanisms 208, 218a, and 218b of FIGS. 2A and 2B, may be provided as any mechanism capable of adjusting the effective refractive index of a coupled waveguide, thereby adjusting the amount of light propagating through the coupled waveguide. For example, as alluded to above, tuning mechanism 208 and/or tuning mechanisms 218a, 218b can be configured to change the refractive index of coupled waveguide over a certain length, for example, through carrier injection (e.g., charge accumulation), charge depletion, or changing the temperature of a portion of the waveguide.

In some implementations, the tuning mechanisms comprise one or more heating elements (e.g., resistive heaters, or the like) that can be operated to change the temperature of a coupled waveguide (e.g., waveguide of a resonator structure 206, 216a, and/or 216b). The heating element may be, for example, a resistor (e.g., metal component) electrically coupled to a portion of the waveguide. A current may then be applied to the heating elements via contact electrode, which generates heat transferred to the respective waveguide causing a change in temperature. Control of the current may tune the temperature so to change the effective refractive.

FIGS. 8A and 8B illustrate an example implementation of an optical device 800 in accordance with implementations disclosed herein. In some implementations, optical device 500 may be implemented as a tuning mechanism, such as tuning mechanisms 208 and/or 218.

FIGS. 8A and 8B illustrate optical device 800 as an example hybrid metal-oxide-semiconductor (MOS) optical device 800. In the case that optical device 800 is used as a tuning mechanism, the optical device 800 can be referred to as a hybrid MOS optical modulator that may be implemented as a tuning mechanism. FIG. 8A is a top-down view of the optical modulator 800 and FIG. 8B is a section view of the hybrid MOS optical device 800 taken along a line A-A′ shown in FIG. 8A.

The optical device 800 includes an optical waveguide 802, a cathode 804 comprising a first material and formed in the optical waveguide 802, and an anode 806 comprising a second material that is different from the first material and formed in the optical waveguide 802. The anode 806 adjoins the cathode 804. A capacitor (also referred to as a capacitive structure) is defined between the anode 806 and the cathode 804. The optical waveguide 802 may be, for example, a portion of one of the waveguides of a resonator structure, such as resonator structure 206, first resonator 216a, and/or second resonator 216b. For example, with reference to FIG. 2A, in the case that optical device 800 is a tuning mechanism 208, waveguide 802 may be a portion of the waveguide of resonator structure 206.

In some examples, a buried oxide (BOX) layer 801 is grown on an underlying substrate 808, which may be provided as silicon. In an example, BOX layer 801 may comprise silicon dioxide (SiO₂). Other examples of materials for substrate 801 may include, but are not limited to, Silicon Nitride (Si₃N₄), Aluminum oxide (Al₂O₃), Hafnium Dioxide (HfO₂), diamond, silicon carbide (SiC), or combinations thereof. A silicon layer 810 is formed on the substrate 801. A trench 812 separates the optical device 800 into two portions 814 and 816. The first portion 814 comprises the anode 806. The optical waveguide 802 is formed in the anode 806. The cathode 804 is integrated to the second portion 816. In various embodiments, the cathode 804 comprises a layer of Group III-V material as the first material. A MOS capacitor 824 (also referred to as a MOSCAP or MOSCAP structure) is defined between the cathode 804 and the anode 806.

A dielectric 818 is formed between the cathode 804 and the anode 806. The dielectric 818 may be an electrically insulating material formed between the cathode 804 and anode 806 of the MOS capacitor 824, and the polarization of the dielectric 818 by an applied electric field may increase the surface charge of the MOS capacitor 824 for a given electric field strength. The dielectric 818 can be native oxides of the cathode or the anode or both, or can be external dielectric materials such as high-k dielectrics or polymers which can be formed by deposition, oxidation, wafer bonding or other dielectric coating methods.

The cathode 804 may comprise negatively-doped Group III-V material (such as indium phosphide (InP), germanium (Ge), gallium arsenide (GaAs), aluminum gallium arsenide (AlGaAs), indium gallium arsenide (InGaAs), indium arsenide (InAs), or combinations thereof) and the anode 806 may comprise positively-doped silicon. In an illustrative example, cathode 804 comprises GaAs. A cathode electrode 820 is disposed on the cathode 804 and an anode electrode 822 is disposed on the anode 806. When a voltage is applied between the electrodes, carrier accumulation, depletion or inversion can occur around dielectric 818. Due to the capacitor region overlapping with the optical waveguide, carrier concentration change may lead to changes in refractive index and propagation loss within waveguide 802. By biasing the voltage applied between the electrodes, the refractive index may be modulated accordingly, thereby inducing optical intensity modulation, phase shift modulation, and attenuation.

In the case where device 800 is implemented as a tuning mechanism according to the implementations disclosed herein, an optical signal propagating through optical waveguide 802 is modulated, attenuated, and phase shifted based on changes in the waveguide modal refractive index induced by applying a voltage biasing to the MOS capacitor 824. The modulated and attenuated optical signal continues along the optical waveguide 802.

For example, FIG. 8A includes a DC power source 826. The DC power source 826 acts as a signal source and has a negative terminal connected to the cathode electrode 820 and a positive terminal connected the anode electrode 822. This results in a migration of negative charges from the cathode 804 toward a side of the optical waveguide 802 adjacent to the cathode 804, and migration of positive charges (“holes”) from the anode 806 to an opposite side of the waveguide 802 (also referred to herein as accumulation mode). In other examples the polarity of the DC power source 826 may be reversed. Reversing the polarity of the DC power source 826 causes a migration of negative charges from the waveguide 802 toward cathode electrode 820, and migration of holes from the waveguide 802 toward anode electrode 822 (also referred to herein as depletion mode).

The MOS capacitor 824 forms at the boundary between the Group III-V material of the cathode 804 and the underlying capacitor portion of the intrinsic silicon or other Group IV material. A thin layer of silicon and the Group III-V oxides (e.g., dielectric 818) forms naturally at this boundary and serves as a dielectric for the capacitor. In some examples, this thin layer has a thickness on a nanoscale, for example, a few nanometers thick. In some examples, steps need not be taken to encourage the formation of dielectric 818. In other examples, the formation of dielectric 818 may be stimulated, for example by elevating the temperature, exposing the materials to an oxygen-rich atmosphere, or other suitable technique. Materials that can be used to form the dielectric 818 may include, but not limited to, SiO₂, Si₃N₄, Al₂O₃, HfO₂, polyimide, benzocyclobutene (BCB), or combinations thereof.

As discussed previously, the MOS capacitor 824 is formed along the optical waveguide 802 so that charge carriers that accumulate/deplete on either side of the capacitor dielectric have the effect of changing the index of refraction of the optical waveguide and waveguide loss (e.g., loss or attenuation of propagated signal power in the waveform).

The MOS capacitor 824 can operate in accumulation, depletion or inversion mode (e.g., accumulation of electrons at the dielectric layer in addition to presence of holes). As discussed above, a DC voltage can be applied between an anode and cathode, causing a thin charge layer to accumulate, deplete, or invert on both sides of the dielectric layer 818. The resulting change in free carrier density causes a change in refractive index n of the optical waveguide 802, which is manifested as a change in the effective refractive index of the optical mode (Δn_{eff}). The amount of change or modulation in the effective refractive index (Δn_{eff}) and associated change in optical losses (Δα) can be described with as follows:

$$Δ {n}_{eff} = \frac{- {q}^{2} {λ}_{0}^{2}}{8 {π}^{2} {c}^{2} n {ε}_{0}} ( \frac{Δ {N}_{e}}{{m}_{c e}^{*}} + \frac{Δ {N}_{h}}{{m}_{c h}^{*}} ) \qquad Eq . 3$$

$$Δα = \frac{- {q}^{3} {λ}_{0}^{2}}{4 {π}^{2} {c}^{3} n {ε}_{0}} ( \frac{Δ {N}_{e}}{{m}_{c e}^{* 2} {μ}_{e}} + \frac{Δ {N}_{h}}{{m}_{c h}^{* 2} {μ}_{h}} ) \qquad Eq . 4$$

Where q is electrical charge applied to the cathode 804 and the anode 806, c is the speed of light in vacuum, co is the permittivity of free space, n is the material refractive index, ΔN represents a change in carrier density such that ΔNₑ represents the change in carrier density in terms of electrons that ΔNₕ represents the change in carrier density in terms of holes, m* represents the relative effective mass of electrons (m*_{ce}) and holes (m*_{ch}), μₕ represents the hole mobility, μₑ represents the electron mobility, and λ₀ is the free space wavelength.

The intensity of an optical signal at the end of the capacitor depends on the magnitude of the voltage-induced Δn_{eff} and optical wavelength λ (e.g., alignment with a resonance frequency of the resonator structure). Thus, the amplitude of an input signal on optical waveguide 802 may be tuned based on the voltage-induced Δn_{eff}. In various examples, the waveguide loss in silicon and the Group III-V material may also change simultaneously as carrier density changes, and control of the change in the waveguide loss can be used as an optical attenuator. For example, changes in waveguide loss may be controlled based on the change in carrier density, which may impart attenuation of the waveguide losses. The attenuated waveguides losses can be used to modulate a signal.

In an illustrative implementation, cathode 804 comprises a negatively-doped GaAs layer and anode 806 comprises a positively doped silicon later. The anode 806 may comprise a first positively doped region formed of the waveguide 802, and a second positively doped region that contacts anode electrode 822. The second region may have a higher doping concentration than the first region. In this example implementation, the cathode 804 may be approximately 190 nm thick, the substrate 801 may be approximately 2 μm thick, and the silicon layer 810 may be 300 nm thick. The space between optical waveguide 802 and anode electrode 822 may be approximately 750 nm. The optical waveguide 802 may be approximately 0.5 μm wide.

FIG. 8C illustrates optical device 800 formed as a ring resonator optical modulator (e.g., an MRR). In this case, trench 812 is provided as an annular trench that divides the optical modulator into first and second portions 814 and 816, respectively. Similarly, the anode 806 is provided as an annular-shaped anode in the second portion and the cathode 804, dielectric 818, and the silicon layer 810 are cylindrical in shape in the first portion. The MOS capacitor 824 is defined across a boundary between the cathode and the anode. The optical waveguide 802 may form the resonator structure 206 or 216. FIG. 8C also depicts a bus waveguides 805a and 805b, which may be an example of an input bus waveguide (e.g., an example of input bus waveguide 202 or 212 of FIGS. 2A and 2B, bus waveguide 102, etc.) and a drop waveguide (e.g., drop waveguide 204 or 214 of FIGS. 2A and 2B, drop waveguides 104, etc.).

As described above, the depletion or accumulation of charges at the interfacial layer results in a change of free carrier density that changes the local refractive index of the waveguide 802. As described above, the change in the refractive index of waveguide 802 may be used to tune the intensity of an optical signal that is output onto a bus waveguide (e.g., bus waveguide 805). When used as a tuning mechanism according to the implementations disclosed herein, the intensity based on a voltage bias to the MOSCAP 824 may be used to tune the weight applied to an input signal. As

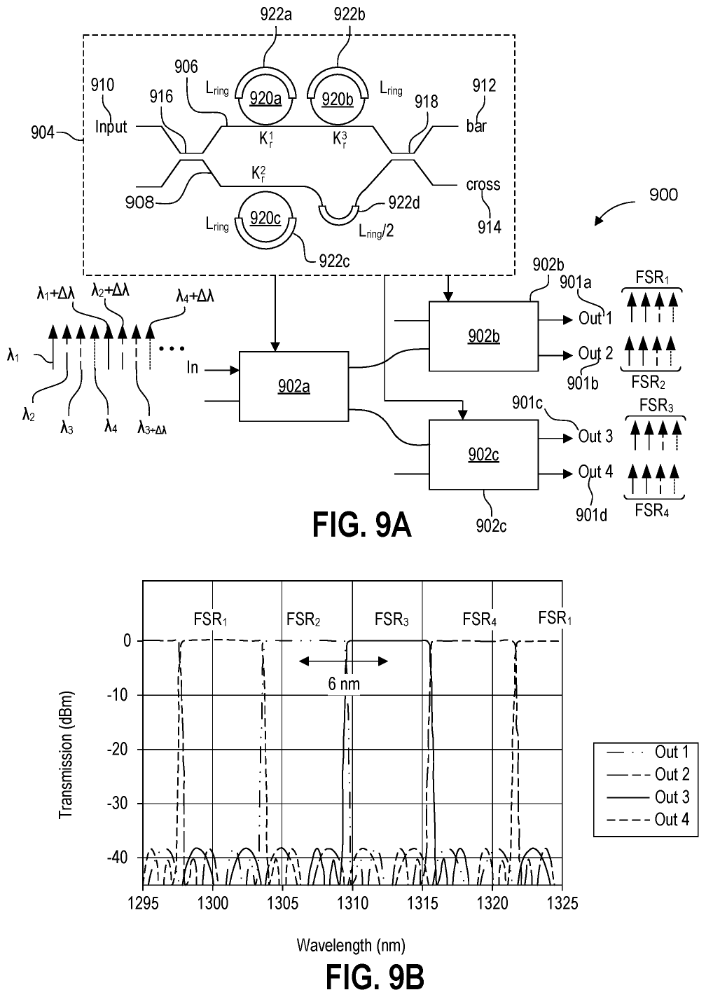

FIG. 9A illustrates a demultiplexer 900 in accordance with an example implementation. FIG. 9A provides an example demultiplexer 900 implemented as a multi-stage de-interleaver. Demultiplexer 900 may be implemented as one of demultiplexers 414 of FIG. 4 and/or demultiplexers 518 of FIG. 5.

Demultiplexer 900 comprises a plurality of ring-assisted Mach-Zehnder interferometers (RAMZIs) 902a through 902c arranged in multiple stages (collectively referred to herein as RAMZIs 902) coupled to waveguides. In an example implementation, a first stage comprises a first RAMZI 902a is couple to at an output of a drop waveguide of a cross bar array, for example, crossbar array 408 and/or resonator loaded cross bar array 510. Outputs of the first RAMZI 902a are fed to a second stage of the demultiplexer 900. For example, a first output of first RAMZI 902a is coupled to a second RAMZI 902b of the second stage and a second output of first RAMZI 902a is coupled to a third RAMZI 902c of the second stage. Each output 901a-d of second RAMZI 902b and third RAMZI 902c are coupled to a respective output waveguide, such as output waveguides 412 of FIG. 4. Thus, outputs from third RAMZI 902c and second RAMZI 902b can be provided to photodetectors (e.g., photodetector 520 or photodetectors 410) for detecting outputs of a respective entry of a resultant matrix, as described above.

The RAMZIs 902 may function to filter different FSRs onto distinct outputs 901. For example, first RAMZI 902a receives an input signal comprising a number of wavelengths across multiple FSRs. First RAMZI 902a filters the input signal into two spatial outputs, such that FSR₁ and FSR₂ are filtered onto a first output provided to second RAMZI 902b. Second RAMZI 902b then functions to filter FSR₁ onto output 901a and FSR₂ onto output 901b. Additionally, first RAMZI 902a filters FSR₃ and FSR₄ onto a second output provided to third RAMZI 902c. Third RAMZI 902c then functions to filter FSR₃ onto output 901c and FSR₄ onto output 901d.

In the illustrative example of FIG. 9A, two stages of RAMZIs are utilized to filter the input signal, which comprises four FSRs, onto four outputs. However, implementations are not intended to be limited to the two stage de-inteleaver example of FIG. 9A. For example, if the number of FSRs are incremented, such as in a case where a second matrix has more than four columns, the number of RAMZIs can be increased as well to filter the increased number of FSRs onto output waveguides. As an illustrative example, a third stage of one or more RAMZIs may be provided depending on the number of FRSs used to encode the second matrix. Furthermore, in a case where the second matrix has two columns, a single stage implementation of FIG. 9A may be used.

In the example implementation of demultiplexer 900, each RAMZI 902 may be provided using a similar structure. For example, each RAMZI 902 may be provided as a 3-ring RAMZI. For example, RAMZI 902 comprises a MZI 904 having a first branch 906, a second branch 908, an input 910, a first output 912 (also referred to as a bar output), and a second output 914 (also referred to as a cross output). The MZI 904 may be implemented as one or more waveguides that guide the propagation of light (e.g., an optical signal such as a lasing mode). For example, first branch 906 may be formed of a first waveguide and second branch 908 may be formed of a second waveguide. Light propagating in first branch 906 evanescently couples into and out of the second branch at a first coupler 916 coupled to input 910. Similarly, a second coupler 918 is provided at the outputs 912 and 914, in which light can be evanescently coupled into and out of each waveguide. The MZI 904 includes a plurality of resonator cavities 920a-d (illustratively depicted as MRRs), which includes a first resonator cavity 920a and a second resonator cavity 920b coupled to branch 906 and a third resonator cavity 920c coupled to second branch 908. Each resonator cavity 920 comprises a phase-shift mechanism 922a-c. Second branch 908 also comprises phase-shift mechanism 922d coupled to a bend of second branch 908. In the example implementation, resonator cavity 920 are provided substantially equal in length (e.g., same radii) and the bend has a length that is half the length of the resonator cavities 920.

The phase-shift mechanisms 922 are configured to alter a phase of an optical signal propagating therein. Phase-shift mechanisms 922 may be provided as any mechanism capable of inducing a phase shift in light propagating through a respective waveguide (particular examples of phase-shift mechanism are provided below in greater detail). For example, phase-shift mechanisms 922 may be provided as thermal-optical phase-shifts, electro-optical phase-shifters, MOSCAP tuning (e.g., FIGS. 8A-8C), or the like.

The implementation of MZI 904 in each of RAMZI 902 may be substantially the same, except for the length of the resonator cavities of each respective RAMZI 902. For example, in the case of first RAMZI 902a, MZI 904 comprises resonator cavities having a length of L_{ring} as shown in FIG. 9A. In the case of second RAMZI 902b and third RAMZI 902c, the resonator cavity length may be half the length of the resonator cavities of first RAMZI 902a (e.g., ½ L_{ring}). Additionally, according to an example implementation, second RAMZI 902b and third RAMZI 902c may have a difference of a quarter lambda in delay.

MZI 904 may operate based on digital filter theory to obtain poles and zeros of a desired transfer function. For example, phase difference between an optical signal on first branch 906 and an optical signal on second branch 908 may be adjusted via phase-shift mechanisms 922 to tune poles and zeros on the outputs to achieve a desired transfer function. This configuration provides for creation of flat-top and sharp roll-off passbands that propagate on each output 912, 914. For example, each RMAZI 902 operates as a bandpass filter. Each RAMZI 902 filters a first range of wavelengths onto a first output 912 and a second range of wavelengths onto a second output 914. For example, in the case of first RAMZI 902a, the first range of wavelengths may comprise FSR₁ and FSR₂ (e.g., λ₁ through λ₄+Δλ) as a flat-top with sharp roll-off passband and the second range comprises FSR₃ and FSR₄ (e.g., λ₁ through λ₄+Δλ) as a flat-top with sharp roll-off passband. Similarly, in the case of second RAMZI 902b, the first range comprises FSR₁ (e.g., λ₁ through λ₄) and the second range comprises FSR₂ (e.g., λ₁+Δλ through λ₄+Δλ). In the case of second RAMZI 902b, the first range comprises FSR₁ (e.g., λ₁ through λ₄) and the second range comprises FSR₂ (e.g., λ₁+Δλ through λ₄+Δλ).

In the illustrative example of FIG. 9A, the cross-coupling coefficient between each phase-shift mechanisms 922 and respective branch of MZI 904 are selected to provide the desired bandpass filter configured to filter input signals as explained above. In an example implementation, the coupling coefficient between phase-shift mechanism 922a and first branch 906 is approximately 0.96, between phase-shift mechanism 922b and first branch 906 is approximately 0.25; and between phase-shift mechanism 922c and second branch 908 is approximately 0.68. Furthermore, the round-trip lengths of an example implementation for each RAMZI 902 are approximately 74.29 μm, approximately 37.15 μm, and approximately 37.15 μm, respectively. That is, for example, first RAMZI 902a comprises resonator cavities 920 having a round-trip length of approximately 74.29 μm and second and third RAMZIs 902b and 902c comprise resonator cavities 920 having round-trip lengths of approximately 37.15 μm.

FIG. 9B depicts transmission intensity spectral line shapes for the outputs 901a-d of demultiplexer 900 as a function of wavelength. In the example of FIG. 9B, the signal output from the outputs 901 of the demultiplexer 900 correspond to four FSRs, for example, of add-drop filters according to implementations disclosed herein. In the illustrative example, output 901a outputs a range of wavelengths shown in FIG. 9B corresponding to FSR₁, 901b outputs a range of wavelengths shown in FIG. 9B corresponding to FSR₂, 901c outputs a range of wavelengths shown in FIG. 9B corresponding to FSR₃, and 901d outputs a range of wavelengths shown in FIG. 9B corresponding to FSR₄. Each range of wavelengths comprises the integer numbers of each WDM wavelength channel. For example, FSR₁ comprises λ₁ through λ₄, FSR₂ comprises λ₁+Δλ through λ4+Δλ, FSR₃ comprises λ₁+2Δλ through λ₄+2Δλ, and FSR₄ comprises λ₁+3Δλ through λ₄+3Δλ. As shown in FIG. 9B, demultiplexer 900 according to FIG. 9A can be leveraged to achieve an FSR spacing (Δλ) of approximately 6 nm (e.g., 5.85 nm in this example) at 1 dB (referred to as a 1 dB-bandwidth), with crosstalk (e.g., unintended transfer of signals into an adjacent FSR and/or noise) at approximately −38 dB.

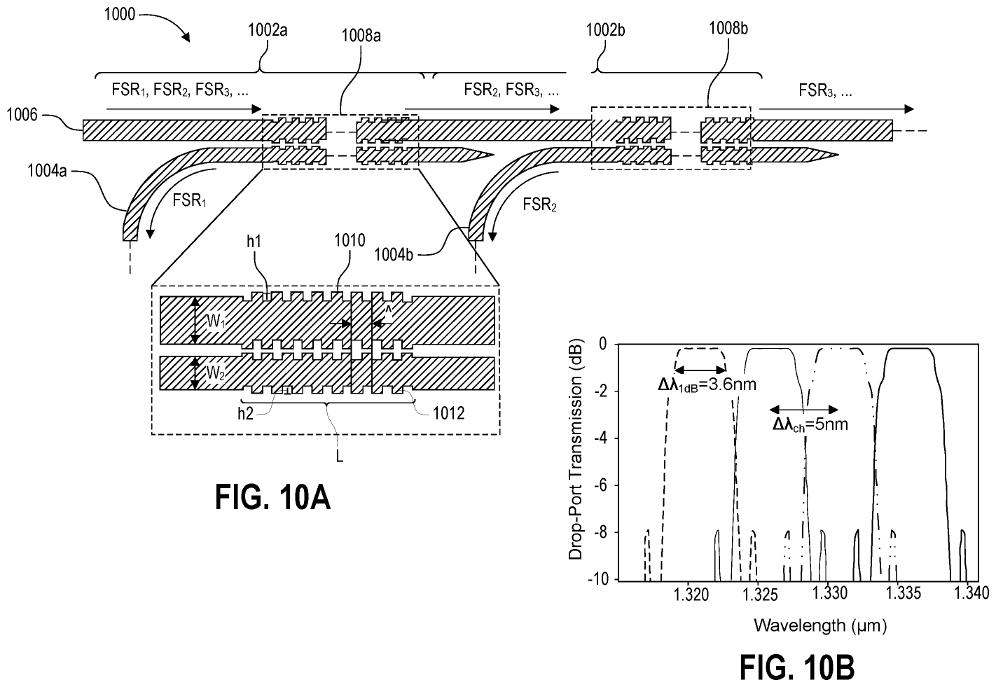

FIG. 10A illustrates another demultiplexer 1000 in accordance with another example implementation. FIG. 10A provides an example CWDM demultiplexer comprising a plurality of cascaded contra-directional couplers (contra-DC) 1002. In the example of FIG. 10A, two contra-DCs 1002a and 1002b are shown, however implementations disclosed herein may comprise more than two. For example, contra DC 1002a is configured to filter optical signals corresponding to FSR₁ on a drop waveguide onto output waveguide 1004a and contra-DC 1002b is configured to filter optical signals corresponding to FSR₂ on a drop waveguide onto output waveguide 1004b. A third contra-DC may be provided corresponding to FSR₃. In some implementations, a fourth contra-DC may be provided. Demultiplexer 1000 may be implemented as one of demultiplexers 414 of FIG. 4 and/or demultiplexers 518 of FIG. 5.

In the example of FIG. 10A, demultiplexer 1000 comprises an input 1006 that may be coupled to a drop waveguide, such as drop waveguides 104, 204, 214, and/or 514 according to the implementations disclosed herein. Input 1002 is coupled to the plurality cascaded contra-DCs 1002, each of which comprises an FSR-specific reflector 1008 that is configured to reflect optical signals of wavelengths corresponding to a specific FSR while transmitting optical signals of other wavelengths. In an illustrative implementation, such as demultiplexers 518 of FIG. 5, three wavelength-specific reflectors 1008 may be provided, where FSR-specific reflectors 1008a corresponds to FSR₁, FSR-specific reflectors 1008b corresponds to FSR₂, and a third FSR-specific reflectors (not shown) corresponds to FSR₃. In one example, a fourth FSR-specific reflectors may be provided that corresponds to FSR₄. Each FSR-specific reflector 1008 can be coupled to a respective output waveguide 1004, which may be example implementation of output waveguides 412, to provide a reflected optical signal to a photodetector (e.g., photodetectors 410 and/or photodetector 520). In another example, Alternatively, an output from input 1006 may correspond to FSR₄ and be provided directly to a photodetector.

In an illustrative example, an optical signal at input 1006 may comprise a spectrum of multiplexed wavelengths received from a crossbar array (e.g., crossbar array 408 and/or resonator loaded cross bar array 510). For example, an optical signal at input 1006 may comprise wavelengths for each entry for a row of a resultant matrix 406 multiplexed into a single signal. Each contra-DC 1002 can be configured to selectively reflect input wavelengths to output waveguides 1004, while maintaining high transmission of the other wavelengths in the through port. In an example implementation, each contra-DC 1002 may comprise a pair of waveguides coupled to an FSR-specific reflector 1008 that comprises a pair of substantially equal-period Bragg gratings comprising small-amplitude perturbations (e.g., on the order of approximately 30 nm to 50 nm) to the waveguide widths in the inner gap. As shown in FIG. 10A, a waveguide of the input may have a width w1 and the output waveguide may have a width w2, which may be smaller than w1. A first Bragg grating 1010 is provided on the input waveguide having a grating period Λ and grating amplitude of h1 (e.g., amplitude perturbations). A second Bragg grating 1012 is provided coupled to the output waveguide 1004 having the grating period Λ (which may be substantially equal to that of grating 1010) and grating amplitude of h2 (which may be smaller than h1). In an example implementation, w1 may be 500 nm and w2 may be 300 nm, Λ may be 250 nm, h1 may be approximately 50 nm, and h2 may be approximately 30 nm. The length L of each Bragg grating 1010 and 1012 may be 0.1 to 1 mm and comprise 1000 gratings. The period Λ of each grating determines which wavelengths are reflected, thus controlled selection of the period can be used to tune the wavelength that will be reflected by each Bragg grating pair.

In this example, selective, FSR-free reflection onto respective output waveguides 1004 can be achieved by Bragg-reflection condition imposed on the coupled-mode of the perturbed asymmetric waveguides due to Bragg-gratings 1010 and 1012. Meanwhile, the reflection of an input mode can be suppressed by anti-symmetric perturbations to the outer portion of the waveguides, allowing for additional FSR channels to be transmitted downstream through the throughput of a contra-DC. Variable wavelengths of FSR channels in cascaded contra-DCs may be attained by adjusting the period of the respective Bragg gratings, and crosstalk between channels can be mitigated via apodization. Compact widths of the components provide for a small footprint (e.g., on the order of 5×10⁻⁵ cm²/channel).

FIG. 10B depicts transmission intensity spectral line shapes for output waveguides 1004 of demultiplexer 1000 as a function of wavelength. As shown in FIG. 10B, at a 1 dB-bandwidth the Δλ is approximately 3.6 nm. The channel width (e.g., Δλ) may be increased, for example, by adding additional Bragg-grating periods, using a full-etch to define perturbations between waveguides, and/or decreasing the gap between waveguides (which is 150 nm in the implementation described above). While a relatively large crosstalk between channels (e.g., exceeding-10 dB) may be present in FIG. 10B, this can be mitigated with apodization of the coupling constant between waveguides.

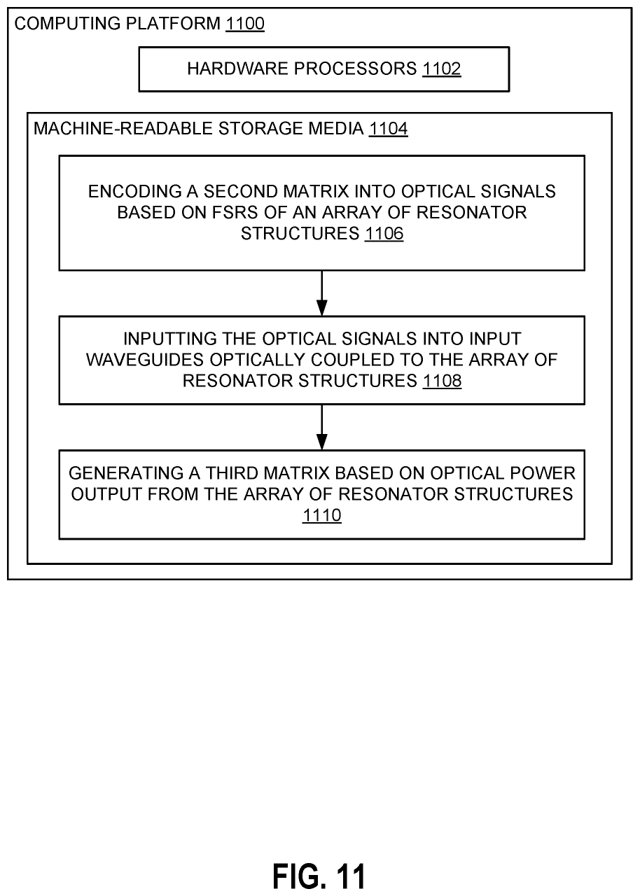

FIG. 11 illustrates an example computing component that may be used to implement general matrix multiplication (GEMM) in accordance with various embodiments. Referring now to FIG. 11, computing component 1100 may be, for example, a server computer, a controller, or any other similar computing component capable of processing data. In the example implementation of FIG. 11, the computing component 1100 includes a hardware processor 1102, and machine-readable storage medium for 1104.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1106-1110, to control processes or operations for performing GEMM. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1106-1110.

Hardware processor 1102 may execute instruction 1106 to encode a second matrix into a plurality of optical signals based on a plurality of FSRs of an array of resonator structures, where the resonator structures can be tuned based on a first matrix. For example, as described above, a second matrix can comprise columns and rows of entries, and columns may be encoded according to different FSRs of the resonator structures. As described above, WDM wavelength channels may be used to encode individual entries into the plurality of optical signals. Furthermore, while each resonator structure can be configured for an initial resonance wavelength, for example, based on round-trip length, the resonance may be tuned according to entries of the first matrix. For example, a bias (e.g., voltage bias) may be applied to tuning mechanism coupled to the resonator structures to tune a transmission intensity output from the resonator structures to provide weighted signals onto drop waveguides. Additional details are provided above in connection with FIGS. 4-10B.

Hardware processor 1102 may execute instruction 1108 to input the plurality of optical signals into input waveguides optically coupled to the array of resonator structures.

Hardware processor 1102 may execute instruction 1110 to generate a third matrix based on optical power output from the array of resonator structures. For example, as described above in connection with FIGS. 4-19B, optical signals can be input into input bus waveguides and weighted based on tuning applied to the resonator structures. The weighted signals are output onto drop waveguides. The weighted signals can be filtered according to FSR, for example, by demultiplexers as described above. The filtered signals are supplied to photodetectors via output waveguides and optical power detected at each photodetector. The total optical power at each photodetector can be translated to an entry of a third, resultant matrix (e.g., product of the first and second matrix).

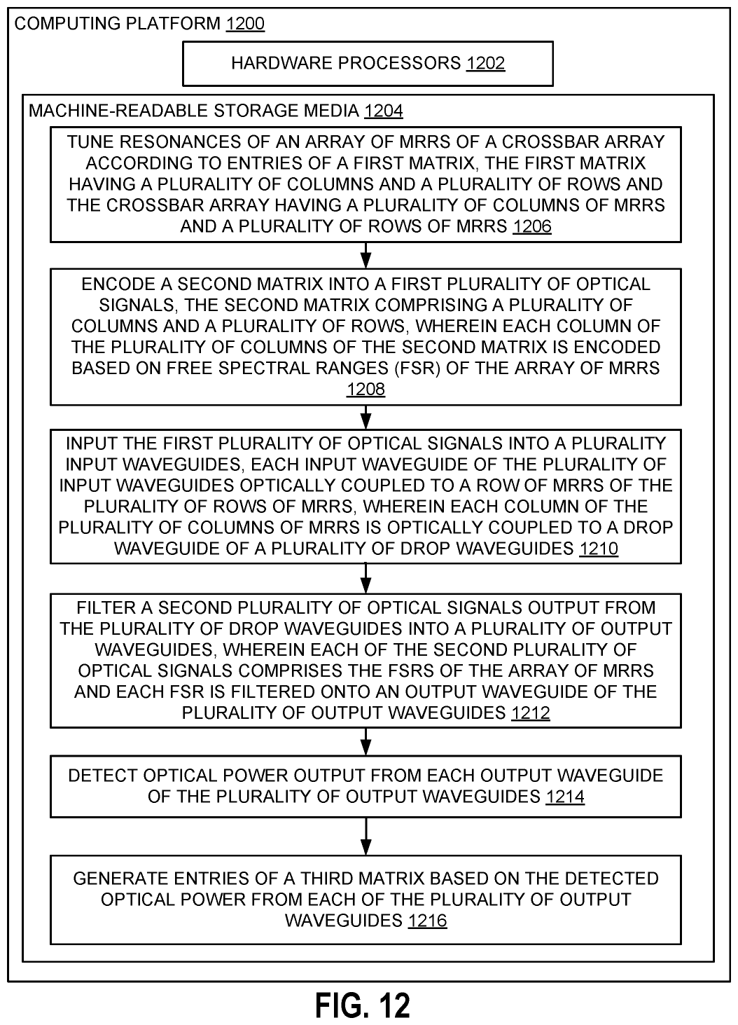

FIG. 12 illustrates another example computing component that may be used to implement GEMM in accordance with an implementation. Referring now to FIG. 12, computing component 1200 may be, for example, a server computer, a controller, or any other similar computing component capable of processing data. In the example implementation of FIG. 12, the computing component 1200 includes a hardware processor 1202, and machine-readable storage medium for 1204.

Hardware processor 1202 may be one or more central processing units (CPUs), semiconductor-based microprocessors, and/or other hardware devices suitable for retrieval and execution of instructions stored in machine-readable storage medium 1204. Hardware processor 1202 may fetch, decode, and execute instructions, such as instructions 1206-1216, to control processes or operations for performing GEMM. As an alternative or in addition to retrieving and executing instructions, hardware processor 1202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1204, may be any electronic, magnetic, optical, or other physical storage device that contains or stores executable instructions. Thus, machine-readable storage medium 1204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1204 may be a non-transitory storage medium, where the term “non-transitory” does not encompass transitory propagating signals. As described in detail below, machine-readable storage medium 1204 may be encoded with executable instructions, for example, instructions 1206-1216.

Hardware processor 1202 may execute instruction 1206 to tune resonances of an array of MRRs of a crossbar array according to entries of a first matrix. The first matrix comprises a plurality of columns and a plurality of rows (e.g., an m×n matrix) and the crossbar array comprises a plurality of columns of MRRs and a plurality of rows of MRRs (e.g., an n×m array of MRRs). In an illustrative example, n is equal to m. FIGS. 1, 4, and 5 provide example crossbar arrays that may be utilized by these instructions.

Hardware processor 1202 may execute instruction 1208 to encode a second matrix into a first plurality of optical signals. The second matrix comprises a plurality of columns and a plurality of rows (e.g., n×k matrix), and each column of the first matrix is encoded based on free spectral ranges (FSR) of the array of MRRs, for example, as described above in connection with FIGS. 4 and 5.

Hardware processor 1202 may execute instruction 1210 to input the first plurality of optical signals into a plurality input waveguides. Each input waveguide of is optically coupled to a row of MRRs of the plurality of rows of MRRs. Each column of MRRs is optically coupled to a drop waveguide of a plurality of drop waveguides. As described above, the number of input waveguides may be the same as the number of rows of the second matrix.

Hardware processor 1202 may execute instruction 1212 to filter a second plurality of optical signals output from the plurality of drop waveguides into a plurality of output waveguides. For example, each drop waveguide receives a weighted signal (e.g., second plurality of optical signals) as a result of applying the tuned resonance of each MRR to the input signals. As a result, each of the second plurality of optical signals comprises the FSRs of the array of MRRs, which can be filtered onto an output waveguide of the plurality of output waveguides, for example, as described above in connection with FIGS. 4 and 5.

Hardware processor 1202 may execute instruction 1214 to detect optical power output from each output waveguide of the plurality of output waveguides. For example, each output waveguide is coupled to a photodetector, which can detect optical power propagating thereon.

Hardware processor 1202 may execute instruction 1216 to generating entries of a third matrix based on the detected optical power from each of the plurality of output waveguides. For example, after filtering, each output waveguide carries optical signals, encoded according to WDM wavelength channels, indicative of a given entry. The optical power can be detected, e.g., by a photodetector, and the total optical power may represent the entry of the third, resultant matrix.

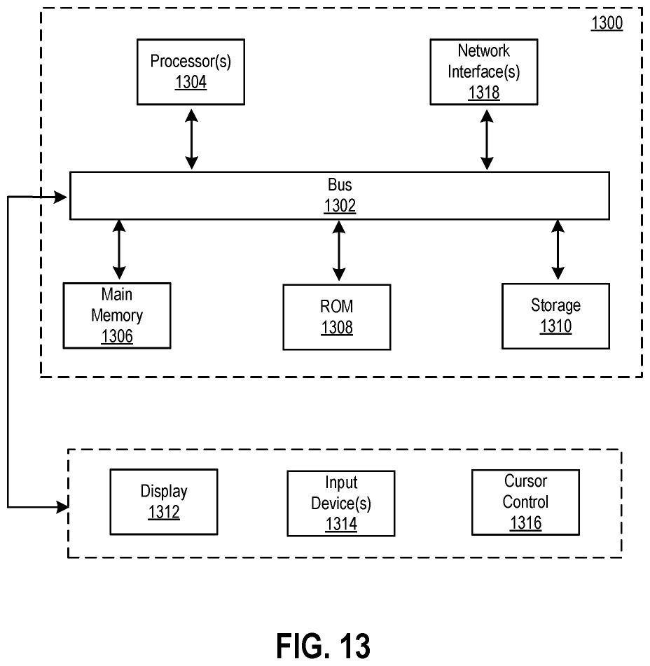

FIG. 13 depicts a block diagram of an example computer system 1300 in which various of the embodiments described herein may be implemented. The computer system 1300 includes a bus 1302 or other communication mechanism for communicating information and one or more hardware processors 1304 coupled with bus 1302 for processing information. Hardware processor(s) 1304 may be, for example, one or more general purpose microprocessors.

The computer system 1300 also includes a main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. For example, main memory 1306 may be store instructions 1106-1110, instructions 1206-1214, for tuning mechanisms disclosed herein (e.g., tuning mechanism 208 and/or tuning mechanisms 218, etc.), among other instructions. Such instructions, when stored in storage media accessible to processor 1304, render computer system 1300 into a special-purpose machine that is customized to perform the operations specified in the instructions.

The computer system 1300 further includes a read only memory (ROM) 1308 or other static storage device coupled to bus 1302 for storing static information and instructions for processor 1304. A storage device 1310, such as a magnetic disk, optical disk, or USB thumb drive (Flash drive), etc., is provided and coupled to bus 1302 for storing information and instructions.

The computer system 1300 may be coupled via bus 1302 to a display 1312, such as a liquid crystal display (LCD) (or touch screen), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. In some embodiments, the same direction information and command selections as cursor control may be implemented via receiving touches on a touch screen without a cursor.

The computing system 1300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1300 may implement the techniques described herein using customized hard-wired logic, one or more ASICs or FPGAS, firmware and/or program logic which in combination with the computer system causes or programs computer system 1300 to be a special-purpose machine. According to one embodiment, the techniques herein are performed by computer system 1300 in response to processor(s) 1304 executing one or more sequences of one or more instructions contained in main memory 1306. Such instructions may be read into main memory 1306 from another storage medium, such as storage device 1310. Execution of the sequences of instructions contained in main memory 1306 causes processor(s) 1304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1310. Volatile media includes dynamic memory, such as main memory 1306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1302. Transmission media can also take the form of acoustic or light waves, such as those generated during radio-wave and infra-red data communications.

The computer system 1300 also includes a communication interface 1318 coupled to bus 1302. Network interface 1318 provides a two-way data communication coupling to one or more network links that are connected to one or more local networks. For example, communication interface 1318 may be an integrated services digital network (ISDN) card, cable modem, satellite modem, or a modem to provide a data communication connection to a corresponding type of telephone line. As another example, network interface 1318 may be a local area network (LAN) card to provide a data communication connection to a compatible LAN (or WAN component to communicated with a WAN). Wireless links may also be implemented. In any such implementation, network interface 1318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1318, which carry the digital data to and from computer system 1300, are example forms of transmission media.

The computer system 1300 can send messages and receive data, including program code, through the network(s), network link and communication interface 1318. In the Internet example, a server might transmit a requested code for an application program through the Internet, the ISP, the local network and the communication interface 1318.

The received code may be executed by processor 1304 as it is received, and/or stored in storage device 1310, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1300.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of performing general matrix multiplication (GEMM), the method comprising:
encoding a second matrix into a plurality of optical signals based on a plurality of free spectral ranges (FSRs) of an array of resonator structures, the resonator structures having resonances tuned based on a first matrix;
inputting the plurality of optical signals into input waveguides optically coupled to the array of resonator structures; and
generating a third matrix based on optical power output from the array of resonator structures.

2. The method of claim 1, further comprising:
tuning resonances of the array of resonator structures according to entries of the first matrix.

3. The method of claim 2, tuning resonances of the array of resonator structures according to entries of the first matrix further comprises:
adjusting a plurality of biases applied to a plurality of tuning mechanisms of array of resonator structures according to the first matrix, wherein the plurality of adjusted biases tunes a transmission intensity of optical signals output from the plurality of resonator structures onto a plurality of drop waveguides coupled to the resonator structures of the array of resonator structures.

4. The method of claim 1, further comprising:
filtering output optical signals onto a plurality of output waveguides from a plurality of drop waveguides coupled to the array of resonator structures, wherein optical signals associated with each FSR of the plurality of FSRs are filtered onto individual output waveguides of the plurality of output waveguides; and
detecting optical power output from each output waveguide of the plurality of output waveguides,
wherein each entry for the third matrix is generated from the detected optical power from each output waveguide of the plurality of output waveguides.

5. The method of claim 4, wherein each drop waveguide is coupled to a demultiplexer configured to filter the output optical signals onto the plurality of output waveguides.

6. The method of claim 1, wherein the plurality of resonator structures comprises a plurality of microring resonators.

7. The method of claim 1, wherein the first matrix comprises a plurality of columns and a plurality of rows, and the second matrix comprises a plurality of columns and a plurality of rows.

8. The method of claim 7, wherein encoding the second matrix into the plurality of optical signals based on the plurality of FSRs of the array of resonator structures further comprises:
encoding each column of the second matrix using a different FSR of the plurality of FSRs; and
encoding each entry of the second matrix using wavelength-division multiplexing.

9. The method of claim 8, wherein channel spacing between each FSR of the plurality of FSRs is equal to or greater than the number of rows or columns of the first matrix (whichever is larger) times the channel spaces between each wavelength-division multiplexing channel.

10. A tensor core, comprising:
a resonator cavity loaded crossbar array comprising a plurality of input waveguides, a plurality of drop waveguides, and a plurality of resonator structures coupled to the plurality of input waveguides and the plurality of drop waveguides; and
one or more processors coupled to a memory storing instructions, the one or more processors configured to execute the instructions to:
encode a second matrix into a plurality of optical signals based on a plurality of free spectral ranges (FSRs) of the plurality of resonator structures;
tune resonances of the plurality of resonator structures according to entries of a first matrix;
input the plurality of optical signals into the input waveguides optically coupled to the plurality of resonator structures; and
generating a third matrix based on optical power output from the plurality of resonator structures onto the plurality of drop waveguides.

11. The tensor core of claim 10, wherein the first matrix comprises a plurality of columns and a plurality of rows, and the second matrix comprises a plurality of columns and a plurality of rows.

12. The tensor core of claim 11, wherein the one or more processors are further configured to:
encode each column of the second matrix using a different FSR of the plurality of FSRs; and
encoding each entry of the second matrix using wavelength-division multiplexing.

13. The tensor core of claim 10, wherein each resonator structure of the plurality of resonator structures comprise one or more microring resonators.

14. The tensor core of claim 10, further comprising:
a plurality of tuning mechanisms coupled to the plurality of resonator structures,
wherein the one or more processors are further configured to adjust a voltage bias applied to each tuning mechanism of the plurality of tuning mechanism according to entries of the first matrix.

15. The tensor core of claim 14, wherein the plurality of tuning mechanism comprise a plurality of metal oxide semiconductor capacitors.

16. The tensor core of claim 10, further comprising:
a plurality of demultiplexers coupled to the plurality of drop waveguides and configured to receive weighted signals from the plurality of drop waveguides, the weighted signals comprise the plurality of FSRs; and
a plurality of output waveguides coupled to outputs of the plurality of demultiplexers,
wherein each demultiplexer is configured to filter each FSR of the plurality of FSRs onto an output waveguide of the plurality of waveguides.

17. The tensor core of claim 16, wherein the plurality of demultiplexers comprises a plurality of de-interleavers.

18. The tensor core of claim 16, wherein the plurality of demultiplexers comprises a plurality of contra-directional couplers.

19. The tensor core of claim 16, further comprising a plurality of photodetectors coupled to the plurality of output waveguides, wherein the plurality of photodetectors are configured to detect optical power output from the plurality of output waveguides, wherein the entries for the third matrix are generated based on the detected optical power.

20. A non-transitory computer-readable storage medium having stored thereon executable computer program instructions that, when executed by one or more processors, cause the one or more processors to perform operations comprising:
tuning resonances of an array of microring resonators (MRRs) of a crossbar array according to entries of a first matrix, the first matrix having a plurality of columns and a plurality of rows and the crossbar array having a plurality of columns of MRRs and a plurality of rows of MRRs;
encoding a second matrix into a first plurality of optical signals, the second matrix comprising a plurality of columns and a plurality of rows, wherein each column of the plurality of columns of the second matrix is encoded based on free spectral ranges (FSR) of the array of MRRs;
inputting the first plurality of optical signals into a plurality input waveguides, each input waveguide of the plurality of input waveguides optically coupled to a row of MRRs of the plurality of rows of MRRs, wherein each column of the plurality of columns of MRRs is optically coupled to a drop waveguide of a plurality of drop waveguides;
filtering a second plurality of optical signals output from the plurality of drop waveguides into a plurality of output waveguides, wherein each of the second plurality of optical signals comprises the FSRs of the array of MRRs and each FSR is filtered onto an output waveguide of the plurality of output waveguides;
detecting optical power output from each output waveguide of the plurality of output waveguides; and
generating entries of a third matrix based on the detected optical power from each of the plurality of output waveguides.
